(19) United States
(12) Patent Application Publication
(10) Pub. No.: US 2007/0230453 A1
(43) Pub. Date: Oct. 4, 2007

(54) Method and System for the Secure and Transparent Provision of Mobile Ip Services in an Aaa Environment

(75) Inventors: Gerardo Giaretta, Torino (IT); Ivano Guardini, Torino (IT); Elena Demaria, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Telecom Italia S.p.A., Milano (IT)

(21) Appl. No.: 10/588,450

(22) PCT Filed: Feb. 6, 2004
(86) PCT No.: PCT/EP04/01105

§ 371 Date: Aug. 4, 2006

(51) Int. Cl. H04L 12/56

(52) U.S. Cl. 370/389

(57) ABSTRACT

A system for negotiating the provision of a mobile IP service, such as, MIPv4 or MIPv6, between a mobile node and a server in a network includes the steps of providing an authentication protocol establishing a pass-through transport between the mobile node and the server and negotiating the provision of the mobile IP service via the authentication protocol over the pass-through transport.

### FIELD OF THE INVENTION

The present invention relates to techniques for accessing networks.

The invention was devised by paying specific attention to the possible application to scenarios where a mobile user is allowed to freely move between, say, a wide-area cellular network and so-called “hot spot” provided e.g. at an airport, a station, or the like.

Reference to those possible fields of application is of exemplary nature only and must not be construed in a limiting sense of the scope of the invention.

### DESCRIPTION OF THE RELATED ART

In order to gain access to a network, a user (fixed or mobile) must perform a set of authentication and authorization steps by providing his or her credentials to the network. The user terminal provides that information to an element of the access network (called the AAA client, where AAA is an acronym for Authentication, Authorization and Accounting). The AAA client checks the data received by interacting with a server (AAA server) in the network of the user provider.

In view of the different problems related to managing the two networks sections involved in the process, communication is based on two different protocols, namely:
an access protocol (e.g. IEEE 802.1x—see, for reference, the IEEE standard 802.1x-2001— or PANA—see draft-ietf-pana-pana-02) in communication between the user and the AAA client node (that is an Access Point or router), and
a so-called backbone protocol (e.g. Radius—see rfc2138—or Diameter—see rfc3588) in communication between the AAA client and the AAA server.

Throughout this description, reference will be made to standards or norms of the rfc . . . , or draft- . . . type. The related information is publicly available at the filing date of the instant application on the IETF (Internet Engineering Task Force) website at http://www.ietf.org

The block diagram of FIG. 1 schematically depicts the standard architecture for accessing a network as discussed in the foregoing.

Specifically, in the diagram of the FIG. 1, U denotes the user, UPN denotes the network of the user's provider, AN3 and AN2 represent two access networks associated with the network UPN. Additionally, 100 designates the authentication step performed via an AAA access protocol 102 (e.g. IEEE 802.1x) while 104 indicates the AAA backbone protocol (e.g. Diameter).

When the scenario shown in FIG. 1 is characterised by the presence of mobile users, the need arises of allowing such users to be reached wherever they are located while keeping application sessions active even when the user position changes.

Specifically, the solution proposed by IETF in order to solve that problem is to use a Mobile IP protocol (MIP) or service which is available both for IPv4 (see rfc3344) and for IPv6 (see draft-ietf-mobileip-ipv6-24).

By adopting the Mobile IP protocol, two IP addresses are assigned to the user's Mobile Node MN: the former is the Home Address (HoA), which is never changed and is used to identify in an univocal manner the node identity; the latter is the Care-of Address (CoA), that is an address belonging to the visited sub-network and is used to identify the real position of the mobile terminal.

Any displacement leading to a change in the IP sub-network involved causes the mobile terminal to record a new Care-of Address with a server, designated Home Agent (HA), in the provider network UPN (see reference 106 in FIG. 1). Any terminal trying to communicate with the mobile terminal by contacting it via the provider network (that is via the Home Address) is re-directed by the Home Agent towards its actual position, which is identified via the Care-of Address. In that way, the Mobile Node is adapted to be reached constantly regardless of its actual connection point to the network.

Using the Mobile IP protocol requires the Mobile Node and the Home Agent to share a set of configuration parameters (the Home Address, the security parameters required in order to protect the signalling messages exchanged and so on). These must be set manually by the network administrator since the standards do not provide automatic mechanisms for initialising (or bootstrapping) the protocol when the Mobile Node is turned on. The manual intervention on the Home Agent and the Mobile Node also plays the role of an implicit authorization mechanism for using the service. Only those users that are explicitly enabled with the Home Agent may avail themselves of the Mobile IP service in order to maintain continuity of application sessions during displacements.

This approach is extremely cumbersome in terms of managing/administrative tasks in view of possible application within an operator network that may have millions of users and a correspondingly high number of Home Agents.

In order to solve that problem, a solution has been proposed within IETF known as the Mobile IPv6 Diameter Application (see draft-le-aaa-Diameter-mobileipv6-03). That solution defines a set of extensions of the Diameter protocol that may be used by an AAA server to exchange information concerning the Mobile IP service simultaneously with the authentication and authorization phase for network access. By using these extensions, the AAA server may control the Home Agent and dynamically send to the mobile node MN of the user U those parameters required for using the Mobile IP protocol (the Home Address, the Home Agent address, etc.). Interaction between the AAA server and the mobile node involves in any case the direct intervention of the AAA client: this one receives the information sent by the AAA server via the backbone protocol 104 (e.g. Diameter), and, after interpreting it, forwards it to the mobile node MN via new information fields defined in the access protocol 102. This arrangement is shown in FIG. 2 wherein MIP data are designated MIPD while reference A generally designates the information exchanged for authentication purposes.

The arrangement shown in FIG. 2 has two basic advantages:
it allows the operator to maintain a centralised management (on the AAA server) of the user profiles and the authentication, authorization and accounting procedures for any type of service, including the Mobile IP service;
it improves reliability and performance of the Mobile IP service, in that the Home Agent to be dynamically allotted to the mobile terminal U can be freely chosen among those that are closest to the user's point of attachment, thus reducing the delay in transferring the traffic toward its destination.

Irrespective of these advantages, the arrangement shown of FIG. 2 also exhibits a number of essential disadvantages, which make it difficult to consider the possible application thereof to commercial communication networks.

First of all, the expected behaviour of the Mobile Node (user U) requires that, when entering a new network or at power-up, the Mobile Node MN listens to the router advertisements, computes the CoA, and creates messages with the CoA as the Source IP address and the AAA client address as the destination IP address (see for direct reference draft-le-aaa-Diameter-mobileipv6-03, page 12). In order to complete the procedure, the Mobile Node must therefore already have IP connectivity available. As a consequence, this prior art solution cannot be used in those access networks where interaction of the mobile terminal and the AAA client is via a level-2 authentication protocol (e.g. IEEE 802.1x). Level-2 authentication is widely diffused in view of the high security standard it provides. This means that the solution in question is not adapted for use in the majority of access network (both present and future).

Additionally, the AAA client, that is required to be the access router (that is it can not be a level-2 apparatus), actively takes part in the negotiation and configuration procedure of the Mobile IP service. Therefore it must support all the protocol extensions required. This significantly limits the platform flexibility, in that deploying new functions requires updating of all the access apparatuses in the network, which may be quite a few. This point is particularly critical in those cases where the Mobile Node is roaming within the network of a provider different from its Home Provider. Under these circumstances, it may be particularly difficult for the provider with whom the user has subscribed the service to ensure that the AAA client in the visited network actually supports all the functions requested for Mobile IPv6 protocol operation.

Finally, the backbone protocol used for exchanging information between the AAA client and the server must be essentially Diameter: in fact, the Radius protocol cannot be extended enough to permit implementing new messages and attributes required for communication between the client and the AAA server.

Essentially the same remarks apply to the solution disclosed in US-A-2003/0147537 (see also draft-ietf-aaa-Diameter-mobileip-15). There, a security key distribution and authentication protocol in AAA for Mobile IP is described. This protocol enhances the security, flexible, scalability of AAA, and aids in protecting the Diffie-Hellman algorithm from man-in-the-middle attacks. A secure registration path in AAA for Mobile IP is set up that provides a secretive and secure key distribution function for AAA.

### OBJECT AND SUMMARY OF THE INVENTION

The need therefore exists of defining arrangements (essentially in the form of architectures/protocols) adapted to integrate the authentication and authorization platform for accessing a network (AAA server and client) with the mobility management platform (HA) by overcoming the drawbacks highlighted in the foregoing while discussing the Mobile IPv6 Diameter application.

According to the present invention, that object is achieved by means of a method having the features said further in the claims that follow. The invention also relates to a corresponding system, a network arrangements based on such a system as well as a terminal, a server and a computer program product loadable in the memory of at least one computer and including software code portions for performing the method of the invention. As used herein, reference to such a computer program product is intended to be equivalent to reference to a computer-readable medium containing instructions for controlling a computer system to coordinate the performance of the method of the invention. Reference to “at least one computer” is evidently intended to highlight the possibility for the present invention to be implemented in a distributed/modular fashion.

A preferred embodiment of the invention is thus a method for negotiating the provision of a mobile IP service between a mobile node and a server in a network, wherein the method includes the steps of:
providing an Extensible Authentication Protocol (EAP) transport between the mobile and the server, and
negotiating the provision of the mobile IP service via the Extensible Authentication Protocol over the transport in question. A presently preferred embodiment of the invention enables a network administrator to control configuration and activation of a Mobile IP service by acting only on the AAA server, where the service profiles for the users are located.

Specifically, the exemplary arrangement described herein includes provisions for:
authorizing use of the Mobile IP service for a given user (for instance, based on his or her subscription),
communicating to the user the options that can be used in connection with the Mobile IP service,
configuring in a dynamic way, both at the Mobile Node and at the Home Agent, those parameters required for using the Mobile IP service (for instance, the home address, the Home Agent address and the cryptographic data to establish the necessary Security Associations), and
authorizing and configuring the options related to the Mobile IP service (for instance, by permitting simultaneous use of several access networks or experimenting higher performance by means of a hierarchical management of mobility).

The arrangement described herein is adapted for use in all access networks that use an EAP protocol (see for instance draft-ietf-eap-rfc2284bis-07) for authentication purposes and exploits the fact that certain EAP authentication methods (such as the method known as PEAPv2—see draft-josefsson-pppext-eap-tls-eap-07) create an encrypted communication channel between the Mobile Node and the AAA server, this channel being adapted both for exchanging authentication information and for transferring information fields that are not strictly related to the authentication process. The arrangement described herein exploits this communication channel in order to perform the exchange of information between the AAA server and the Mobile Node required for authorization purposes and for configuring the Mobile IP service. Upon mobile terminal power-up, all the messages required for activating the MIP service are transferred within RAP fields routed in a transparent way by the AAA client. Consequently, the AAA client simply performs a “pass through” function and does not play any active role in the negotiation process.

The arrangement described herein thus takes advantage of the possibility of exploiting an ZAP method (such as EAP-TLV) for transporting generic information. EAP and TLV are acronyms for Extensible Authentication Protocol and Type Length Value, respectively; see also documents such as draft-hiller-eap-tlv-01 (EAP-TLV) and draft-grayson-eap-authorization-01 (EAP Authorization).

Even if the invention has been described by taking as reference the EAP protocol, it will be apparent to those skilled in the art, that such a protocol can be replaced by any authentication protocol permitting the use of a backend authentication server (for example an AAA server) able to implement some or all authentication methods, with the access equipment (for example the AAA client) Acting as a pass-through for some or all authentication methods.

According to the present invention, the term authentication method refers in particular to the messages exchanged between the mobile node and the backend authentication server at least for authentication purposes.

The arrangement described herein retains all the advantages of prior art solution, while dispensing with the intrinsic limitations related thereto. Specifically, the arrangement described herein:
may be used also for a mobile terminal not already equipped with IP connectivity,
permits use of any level-2 (for instance IEEE 802.1x) or level-3 authentication protocol (for instance PANA) supporting EAP. The arrangement described herein is adapted for use in the large majority of existing networks (and future networks too) since the EAP protocol is/will be supported by the majority of access apparatus in view of the increasing success of EAP as the standard solution for managing security in a wireless environment (for instance WLANs),
permits architecture deployment, and possible extension thereof with new functions, without having to update the access apparatus (i.e. AAA client) and the AAA protocols in use. Only minor changes in the AAA servers and the mobile terminals (at the software level) are required, in that the AAA client does not play an active role in negotiating the service and the EAP protocol is used—also—for negotiation purposes in addition to authentication purposes. This reduces the deployment costs and makes the solution easy to use even when a Mobile Node is roaming with a provider different from its own Home Provider, and
the backbone protocol used for communication between the AAA client and server may be any protocol adapted to support transportation of EAP fields (i.e. not just Diameter, but also other protocols such as Radius). This significantly simplifies the deployment of the arrangement described herein in existing communication networks, where support for Diameter protocol in access apparatus is not so extensive.

### BRIEF DESCRIPTION OF THE DRAWINGS

The invention will now be described, by way of example only, by referring to the enclosed figures of drawings, wherein:

FIGS. 1 and 2 have been already described in the foregoing,

FIG. 3 is a schematic block diagram showing the architecture of the arrangement described herein,

FIG. 4 is a schematic representation of the procedure implemented in the arrangement described herein,

FIG. 5 to 14 represent various phases in the procedure of FIG. 4,

FIG. 15 represents the complete optimised procedure,

FIG. 16 to 19 again represent various steps in an optimised procedure, and

FIG. 20 to 23 are representative of various data structures as used in the arrangement described herein.

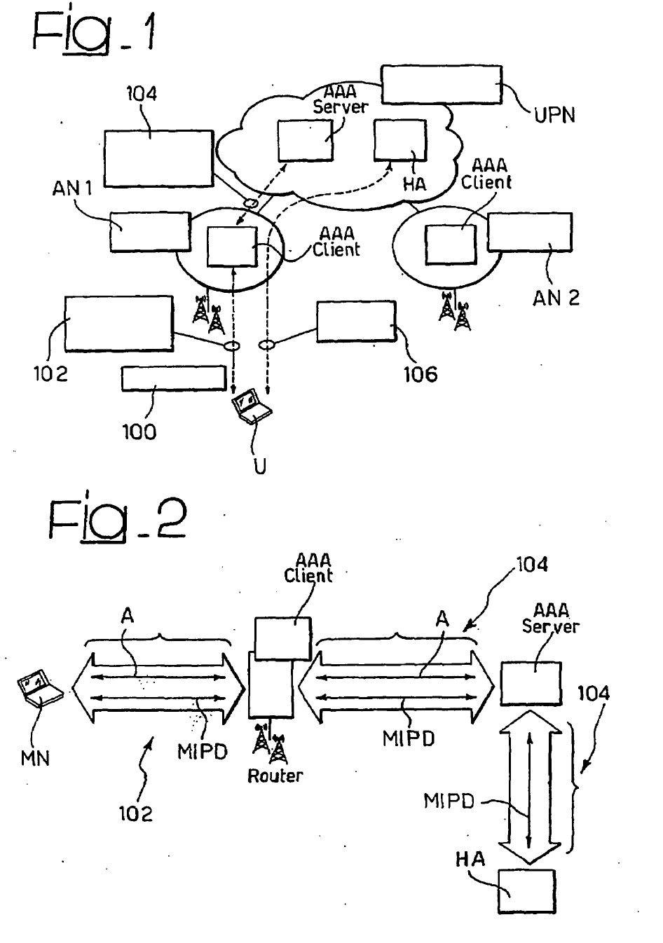

### DETAILED DESCRIPTION OF PREFERRED EMBODIMENTS OF THE INVENTION

The diagram of FIG. 3 represents by way of direct comparison the basic differences existing between the arrangement described herein and the prior art arrangement previously described in connection with the Mobile IPv6 Diameter application.

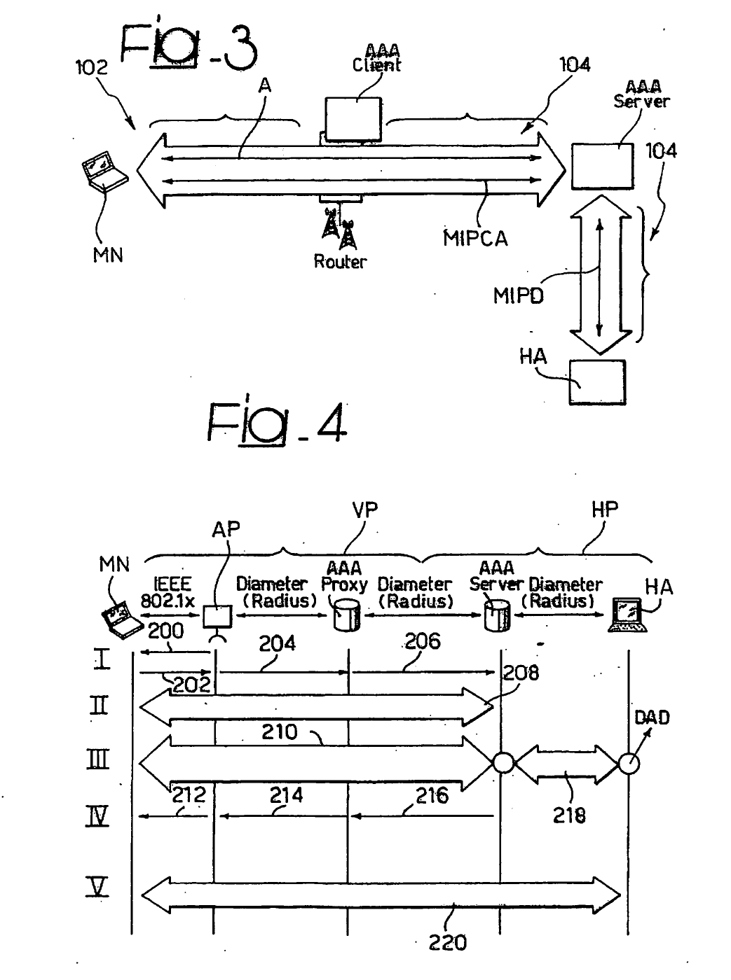

A key difference between the arrangements shown in FIGS. 2 and 3 lies in that in the arrangement of FIG. 3, the AAA client plays a simple “pass through” role and thus is not actively involved in the negotiation process, which is performed at the EAP level.

Specifically, the arrangement described herein aims at integrating the authentication and authorization platform to access a network (that is AAA server and client) with the platform that manages mobility (i.e. Home Agent). The arrangement described hereby enables the administrator to control in an automatic way the configuration and activation of the Mobile IP service by acting only on the AAA server, where the service profiles of all users reside.

The objects that make up the architecture and participate in providing the related functions are the AAA server, the Home Agent HA, and the Mobile Node MN.

The AAA server has a residing module to control in a centralized way the initialisation of the Mobile IP (e.g. Mobile IPv6) service by providing comments and configuration information to the Mobile Node MN and the Home Agent HA.

The residing module of the AAA server can be stored on a memory device, removable or fixed, as for example a mass memory or disk, an internal memory of the server, as for example a ROM (Read Only Memory), a RAM (Random Access Memory) or a removable memory device as a CD.

The Home Agent has a residing module for managing a communication with the AAA server and keeping the configuration information required for using the Mobile IP service by the authorised users (e.g. home address, cryptographic material, privileges provided).

The Mobile Node MN (namely, the user U) has a residing module that, by interacting with the AAA server in an integrated manner with the authentication process, is in a position to collect automatically initialisation parameters required for starting the Mobile IP service on the terminal.

The residing module of the terminal can be stored on a memory device, removable or fixed, as for example a SIM card, a ROM (Read Only Memory), a CD, etc.

Conversely, the apparatus in the access network does not play any active role: specifically, the AAA client (Access Point, access router, and so on) only performs a pass-through function by routing in a transparent way the commands and informative contents exchange between the Mobile Node and the AAA server.

This represents a significant advantage in comparison with other architectures proposed at the IETF level. The configuration of the Mobile IP considered herein has the sole requirement that the access network visited uses the EAP protocol as the authentication protocol. Such a feature is particularly advantageous for deploying the architecture.

In fact, only very minor changes (at the software level) are required to be implemented with the AAA server and the mobile terminals, since the AAA client does not play an active role in the negotiation process of the service. This leads to a reduction in deployment costs and, more to the point, makes this arrangements adapted to be used easily even when the mobile terminal is roaming with a provider different from its Home Provider.

The arrangement described herein involves both the initial configuration of the Mobile Node and the Home Agent (namely the bootstrap phase of the Mobile Node) as well as a set of mechanisms adapted to manage user mobility and the subsequent re-authentication operations, closing of the sessions and the subsequent release of the network resources.

In the following, the exemplary case will be considered where the protocol used by the nodes comprising the AAA infrastructure is Diameter (rfc3588) and the information A related to authentication and authorization in communication between Mobile Node MN, AAA client and AAA server is transported by using the EAP protocol (draft-ietf-eap-rfc2284bis-07) and the authentication method PEAPv2 (protected EAP version 2, see draft-josefsson-pppext-eap-tls-eap-07). In the diagram of FIG. 3, MIPCA denotes the MIP authentication and authorization functions.

For the sake of simplicity, it will be assumed that the access network is a Wireless LAN (WLAN) and the protocol used for communication between the Mobile Node MN and the AAA client is IEEE 802.1x.

As detailed in the following, an operation mode permitting application of the arrangement described herein to 2.5-3G radio mobile networks is also defined.

The bootstrap procedure described in the following is performed with the Mobile Node MN at power-up or upon a first connection to the network.

During that phase, the Mobile Node MN may request the use of the Mobile IP service and self-configure itself under the control of the AAA server, where the data concerning the respective subscription are stored.

The bootstrap procedure described herein has the following purposes:
authorizing the use of the Mobile IP service (MIPv6) by a certain user based on the characteristic of his or her subscription position, and so on,
communicating to the Mobile Node MN those options that may be used in connection with the Mobile IP service (for instance, the possibility of using multiple accesses at the same time via the registration of multiple Care-of Addresses),

configuring in a dynamic way the parameters required for using the Mobile IP service both on the Home Agent HA and the Mobile Node MN; specifically, the possibility exists of communicating to the Mobile Node MN the home address, the address of the Home Agent HA allotted thereto and the cryptographic material required for bootstrapping the IPsec Security Association with the Home Agent HA (that is the security relationship required for ensuring the authenticity of the signalling messages exchanged), and
authorizing and configuring the service options previously communicated to the Mobile Node MN:

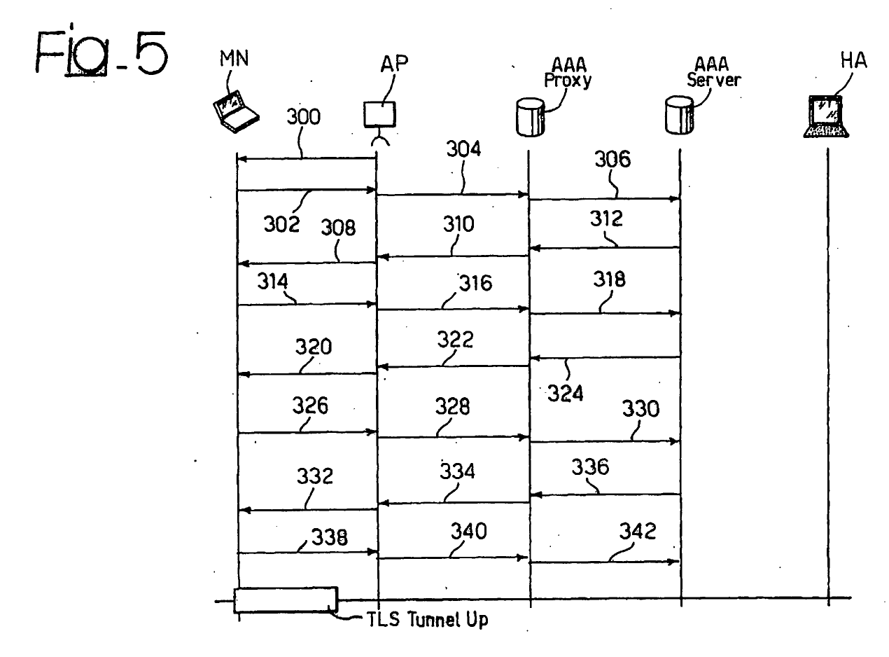

FIG. 4 is a comprehensive representation of the whole bootstrap procedure in the case where the Mobile Node MN accesses a IEEE WLAN supporting the IEEE 802.1x protocol. In that case, the role of the AAA client is played by the Access Point (AP), namely the point of attachment (radio base station) of the WLAN network.

For the sake of completeness, the general case is considered where the user is roaming within the network of a Visited Provider VP different from his or her own Home Provider HP. In the case the user is connected to the network of the Home Provider, the procedure is essentially the same or, more to the point, slightly simpler in that communication between the Access Point AP and the AAA server may take place without resorting to a AAA Proxy.

The procedure represented in FIG. 4 essentially includes five phases designated I) to V).

The first phase, designated I), marks the start of EAP communication. This is prompted by the Access Point AP requesting the Mobile Node MN, in a step 200, for its identity. This identity (e.g. the so-called Network Access Identifier or NAI) is sent by the Mobile Node MN to the Access Point AP in a step 202. The phase described is totally compliant with the standard documented in draft-ietf-eap-rfc2284bis-07, pages 7-8. The step 202 is followed by two further steps 204 and 206 wherein the Diameter EAP Request is sent from the Access Point to the AAA server via the AAA proxy (which is not present in the case the Mobile Node MN is connected to the Home Provider network).

In the subsequent phase, designated II), the Mobile Node MN and the AAA server set up a TLS (Transport Layer Security) tunnel with the purpose of protecting the authentication information. Also this phase is totally in compliance with the PEAPv2 protocol.

In a further PEAPv2 phase, designated III), in addition to performing in a step 210 the authentication procedure as described in draft-josefsson-pppext-eap-tls-eap-07, pages 16-19, the Mobile Node MN and the AAA server exchange a set of attributes (for instance, EAP-TLV—see draft-josefsson-pppext-eap-tls-eap-07, pages 29-35) defined herein in order to authorise, negotiate and configure the Mobile IP service. Additionally, in a step 218 the AAA server selects a Home Agent HA adapted to serve the Mobile Node and communicates to that Home Agent a set of configuration and authorization parameters related to the Mobile Node MN by using corresponding extensions defined for the Diameter protocol.

In the phase designated IV), once the user is authenticated and the Mobile IP service is negotiated, the EAP/PEAPv2 communication is closed as provided in draft-josefsson-pppext-eap-tls-eap-07 pages 16-19 and draft-ietf-eap-rfc2284bis-07, page 8. Specifically, the phase IV) shown in FIG. 4 is comprised of three steps 212, 214 and 216 corresponding to the Diameter EAP Answer (success/failure) being transmitted from the AAA server to the Mobile Node MN via the AAA proxy (if present) and the Access Point AP.

Finally, the phase designated V) is comprised of a step 220 corresponding to the set-up of the Security Association SA IPsec between the Mobile Node MN and the Home Agent HA. Separately from the EAP communication, the Mobile Node MN and the Home Agent HA negotiate Security Association IPsec by using the procedure described in rfc2409 (IKE, Internet Key Exchange). The communication between the Mobile Node MN and the AAA server as well as between the AAA server and the Home Agent (HA) taking place during the phase III) provides the necessary cryptographic material for that negotiation (pre-shared key, digital certificates and so on).

The procedure outlined in the foregoing will now be detailed in connection with the figures that follow FIG. 4.

The bootstrap procedure in the Mobile Node MN starts with a network access and authentication phase that is essentially as provided in the PEAPv2 protocol (see draft-josefsson-pppext-eap-tls-eap-07), for communication between the Mobile Node and the AAA server, and in the Diameter EAP Application (see draft-ietf-aaa-eap-03), for transporting EAP messages in Diameter.

First of all, EAP messages are exchanged with the purpose of setting up a TLS tunnel (that is an encrypted channel) between the Mobile Node MN and the AAA server. The corresponding sequence is highlighted in FIG. 5, where the reference numerals 300 to 342 denote the messages listed in the following table.

For the sake of clarity, the conventions used to represent Diameter and EAP messages throughout this application are summarized here below:
in each Diameter message only the AVPs and command codes that are relevant for this application are represented;
where necessary, the specific content of a Diameter AVP (or EAP message) is written between brackets;
optional AVPs (or TLVs) are written between square brackets;

to simplify the notation, the TLVs contained in the IPv6-Authorization-TLV are written omitting the “-TLV” suffix.

| | |
|---|---|
| 300 | EAP-Request/Identity |
| 302 | EAP-Response/Identity (MyID1) |
| 304 | Diameter-EAP-Request |
| | EAP-Payload-AVP (EAP-Response/Identity) |
| 306 | Diameter-EAP-Request |
| | EAP-Payload-AVP (EAP-Response/Identity) |
| 308 | EAP-Request/EAP-Type = PEAP, V = 2 |
| | (PEAP Start, S bit set) |
| 310 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (PEAP Start, S bit set)) |
| 312 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (PEAP Start, S bit set)) |
| 314 | EAP-Response/EAP-Type = PEAP, V = 2 |
| | (TLS client_hello) |
| 316 | Diameter-EAP-Request |
| | EAP-Payload-AVP (EAP-Response/EAP-Type = PEAP, V = 2 |
| | (TLS client_hello)) |
| 318 | Diameter-EAP-Request |
| | EAP-Payload-AVP (EAP-Response/EAP-Type = PEAP, V = 2 |
| | (TLS client_hello)) |
| 320 | EAP-Request/EAP-Type = PEAP, V = 2 |
| | (TLS server_hello, TLS certificate, TLS |
| | server_hello_done) |
| 322 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (TLS server_hello, TLS certificate, TLS |
| | server_hello_done)) |
| 324 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (TLS server_hello, TLS certificate, TLS |
| | server_hello_done)) |
| 326 | EAP-Response/EAP-Type = PEAP, V = 2 |
| | (TLS client_key_exchange, |
| | TLS change_cipher_spec, TLS finished) |
| 328 | Diameter-EAP-Request |
| | EAP-Payload-AVP (EAP-Response/EAP-Type = PEAP, V = 2 |
| | (TLS client_key_exchange, |
| | TLS change_cipher_spec, TLS finished)) |
| 330 | Diameter-EAP-Request |
| | EAP-Payload-AVP (EAP-Response/EAP-Type = PEAP, V = 2 |
| | (TLS client_key_exchange, |
| | TLS change_cipher_spec, TLS finished)) |
| 332 | EAP-Request/EAP-Type = PEAP, V = 2 |
| | (TLS change_cipher_spec, TLS finished) |
| 334 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (TLS change_cipher_spec, TLS finished)) |
| 336 | Diameter-EAP-Answer |
| | Result-Code = DIAMETER_MULTI_ROUND_AUTH |
| | EAP-Payload-AVP (EAP-Request/EAP-Type = PEAP, V = 2 |
| | (TLS change_cipher_spec, TLS finished)) |
| 338 | EAP-Response/EAP-Type = PEAP, V = 2 |
| 340 | Diameter-EAP-Request |
| | EAP-Payload-AVP (EAP-Response/EAP-Type = PEAP, V = 2) |
| 342 | Diameter-EAP-Request |
| | EAP-Payload-AVP (EAP-Response/EAP-Type = PEAP, V = 2) |

For a complete description of the messages exchanged and their contents reference may be once again to draft-josefsson-pppext-eap-tls-eap-07.

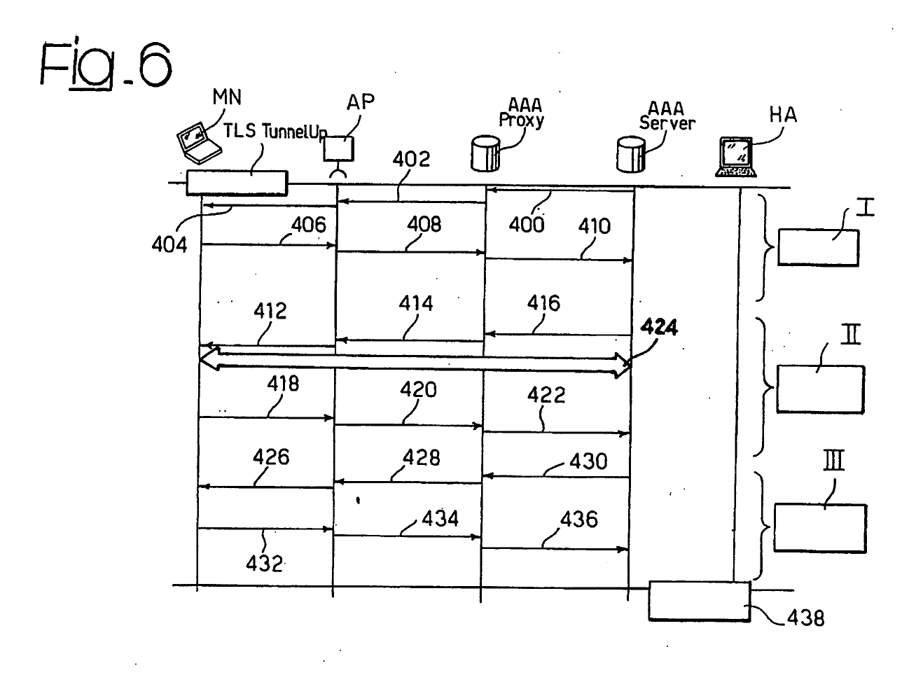

Once the TLS tunnel is set up, the authentication procedure takes place as detailed in FIG. 6.

All the messages exchanged between the AAA server and the Mobile Node MN are encrypted by means of the TLS security relationship previously created. Authentication of the Mobile Node MN may take place by using any of the defined EAP methods (e.g. EAP-SIM or EAP-AKA for SIM-card based authentication). The choice for the method obviously affects the number of Round Trips required to complete the authentication procedure (that is the number of crossings of the network portion between the Mobile Node MN and the AAA server).

FIG. 6 details the messages exchanged in that phase without going into the details of the authentication method used.

Again, a list is provided in the following of the meaning/contents of the steps designated by reference numbers 400 to 438 in FIG. 6.

| | |
|---|---|
| 400 | Diameter-EAP-Answer |
| | Result-Code = DIAMETER_MULTI_ROUND_AUTH |
| | EAP-Payload-AVP (EAP-Request/EAP-Type = EAP-TLV |
| | (EAP-Payload-TLV (EAP-Request/Identity))) |
| 402 | Diameter-EAP-Answer |
| | Result-Code = DIAMETER_MULTI_ROUND_AUTH |
| | EAP-Payload-AVP (EAP-Request/EAP-Type = EAP-TLV |
| | (EAP-Payload-TLV (EAP-Request/Identity))) |
| 404 | EAP-Request/EAP-Type = EAP-TLV |
| | (EAP-Payload-TLV (EAP-Request/Identity)) |
| 406 | EAP-Response/EAP-Type = EAP-TLV |
| | (EAP-Payload-TLV (EAP-Response/Identity (MyID2))) |
| 408 | Diameter-EAP-Request |
| | EAP-Payload-AVP (EAP-Response/EAP-Type = EAP-TLV |
| | (EAP-Payload-TLV (EAP-Response/Identity (MyID2)))) |
| 410 | Diameter-EAP-Request |
| | EAP-Payload-AVP (EAP-Response/EAP-Type = EAP-TLV |
| | (EAP-Payload-TLV (EAP-Response/Identity (MyID2)))) |
| 412 | EAP-Request/EAP-Type = EAP-TLV |
| | (EAP-Payload-TLV (EAP-Request/EAP-Type = X)) |
| 414 | Diameter-EAP-Answer |
| | Result-Code = DIAMETER_MULTI_ROUND_AUTH |
| | EAP-Payload-AVP (EAP-Request/EAP-Type = EAP-TLV |
| | (EAP-Payload-TLV (EAP-Request/EAP-Type = X))) |
| 416 | Diameter-EAP-Answer |
| | Result-Code = DIAMETER_MULTI_ROUND_AUTH |
| | EAP-Payload-AVP (EAP-Request/EAP-Type = EAP-TLV |
| | (EAP-Payload-TLV (EAP-Request/EAP-Type = X))) |
| 424 | Execution of the authentication method (N RTTs) |
| 418 | EAP-Response/EAP-Type = EAP-TLV |
| | (EAP-Payload-TLV (EAP-Response/EAP-Type = X)) |
| 420 | Diameter-EAP-Request |
| | EAP-Payload-AVP (EAP-Response/EAP-Type = EAP-TLV |
| | (EAP-Payload-TLV (EAP-Response/EAP-Type = X))) |
| 422 | Diameter-EAP-Request |
| | EAP-Payload-AVP (EAP-Response/EAP-Type = EAP-TLV |
| | (EAP-Payload-TLV (EAP-Response/EAP-Type = X))) |
| 426 | EAP-Request/EAP-Type = EAP-TLV |
| | (Intermediate-Result-TLV, Crypto-Binding-TLV) |
| 428 | Diameter-EAP-Answer |
| | Result-Code = DIAMETER_MULTI_ROUND_AUTH |
| | EAP-Payload-AVP (EAP-Request/EAP-Type = EAP-TLV |
| | (Intermediate-Result-TLV, Crypto-Binding-TLV)) |
| 430 | Diameter-EAP-Answer |
| | Result-Code = DIAMETER_MULTI_ROUND_AUTH |
| | EAP-Payload-AVP (EAP-Request/EAP-Type = EAP-TLV |
| | (Intermediate-Result-TLV, Crypto-Binding-TLV)) |
| 432 | EAP-Response/EAP-Type = EAP-TLV |
| | (Intermediate-Result-TLV, Crypto-Binding-TLV) |
| 434 | Diameter-EAP-Request |
| | EAP-Payload-AVP (EAP-Response/EAP-Type = EAP-TLV |
| | (Intermediate-Result-TLV, Crypto-Binding-TLV)) |
| 436 | Diameter-EAP-Request |
| | EAP-Payload-AVP (EAP-Response/EAP-Type = EAP-TLV |
| | (Intermediate-Result-TLV, Crypto-Binding-TLV)) |
| 438 | Authentication Completed |

The steps represented in FIG. 6 can be generally grouped in tree sets, namely ID exchange (covering one Round Trip Time or RTT unit) I, the proper authentication algorithm (covering N RTT units) II, and authentication outcome (taking again one RTT unit) III.

In the standard case where PEAPv2 is used for user authentication only, the AAA server terminates the EAP communication with the Mobile Node by means of an EAP-Success message. In the present case, however, EAP communication is not terminated in that the procedure also foresees negotiation of the Mobile IP service. For that reason, as shown in FIG. 6, the AAA server sends a message containing an Intermediate-Result-TLV (see step 430) that witnesses the authentication procedure has been completed without however terminating EAP communication.

When the authentication phase is concluded, namely after the EAP response message containing the Intermediate-Result-TLV (see step 436 in FIG. 6), the AAA server starts the procedure for authorizing the Mobile IP service by sending an EAP message including a new TLV, called MIPv6-Authorization-TLV. This is a quite generic TLV message containing a set of other TLVs that specifies the meaning and the content of the message.

The AAA server inserts in such first message, within the MIP6-Authorization-TLV, a so-called Service-Status-TLV, used to communicate to the Mobile Node MN whether the Mobile IPv6 service is actually available, or unavailable, in the visited location; this might depend on characteristics of the visited domain, on the user service profile or on other administrative rules (for example, service accountability). Optionally the AAA server can insert also a Service-Options-TLV, used to specify other service options the MN can ask for (for example, possibility to register multiple CoAs).

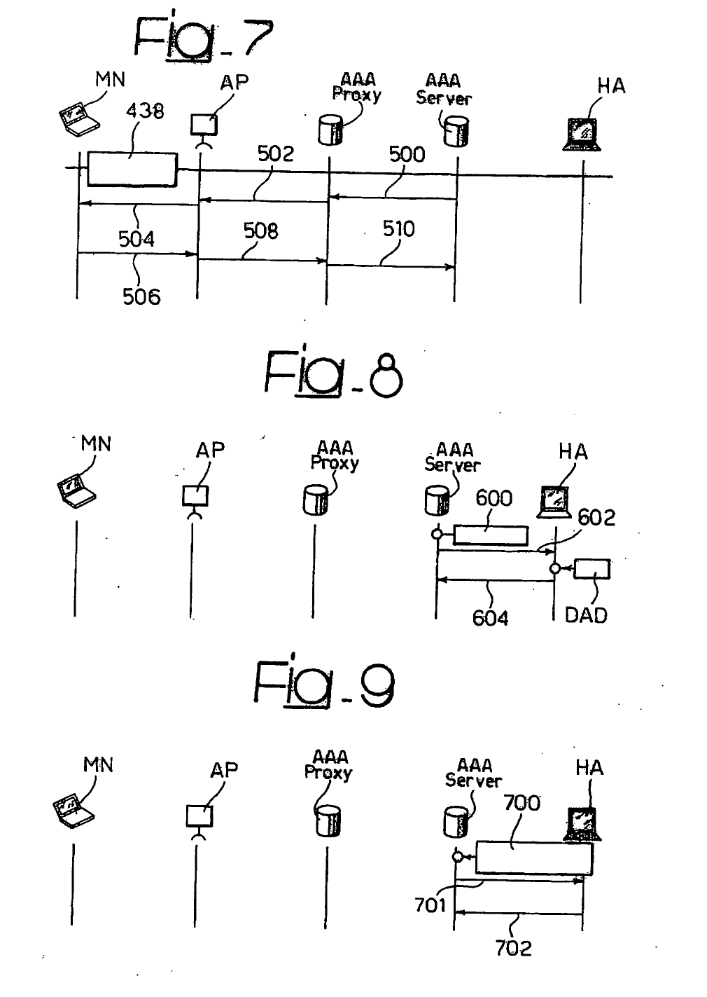

This kind of operation is highlighted in FIG. 7.

Again, in the sequence of the FIG. 7, the block 438 designates the completion of the authentication phase, while the references 500 to 510 designates the following messages.

| | |
|---|---|
| 438 | Authentication completed |
| 500 | Diameter-EAP-Answer |
| | Result-Code = DIAMETER_MULTI_ROUND_AUTH |
| | EAP-Payload-AVP (EAP-Request/EAP-Type = EAP-TLV |
| | (MIPv6-Authorization-TLV |
| | (Service-Status, [Service-Options]))) |
| 502 | Diameter-EAP-Answer |
| | Result-Code = DIAMETER_MULTI_ROUND_AUTH |
| | EAP-Payload-AVP (EAP-Request/EAP-Type = EAP-TLV |
| | (MIPv6-Authorization-TLV |
| | (Service-Status, [Service-Options]))) |
| 504 | EAP-Request/EAP-Type = EAP-TLV |
| | (MIPv6-Authorization-TLV (Service-Status, |
| | [Service-Options])) |
| 506 | EAP-Response/EAP-Type = EAP-TLV |
| | (MIPv6-Authorization-TLV (Service-Selection, |
| | [Service-Options], [Home-Agent-Address], |
| | [Home-Address], [Interface-Identifier])) |
| 508 | Diameter-EAP-Request |
| | EAP-Payload-AVP (EAP-Response/EAP-Type = EAP-TLV |
| | (MIPv6-Authorization-TLV |
| | (Service-Selection, [Service-Options], |
| | [Home-Agent-Address], [Home-Address], |
| | [Interface-Identifier]))) |
| 510 | Diameter-EAP-Request |
| | EAP-Payload-AVP (EAP-Response/EAP-Type = EAP-TLV |
| | (MIPv6-Authorization-TLV |
| | (Service-Selection, [Service-Options], |
| | [Home-Agent-Address], [Home-Address], |
| | [Interface-Identifier]))) |

Specifically, the Mobile Node MN responds to the message sent by the AAA server by indicating whether the Mobile IP service is to be activated and, possibly, the related options.

The message in question includes the following TLVS:
Service-Selection-TLV: this indicates the choice of the Mobile Node MN to activate the Mobile IP service;
Service-Options-TLV: this is an optional TLV that allows the Mobile Node MN to indicate what service options among those proposed by the AAA server are to be activated;
Home-Agent-Address-TLV: this is again an optional TLV by means of which the Mobile Node MN may specify the address of a preferred Home Agent HA. This TLV may be present when the Mobile Node has a pre-configured security relationship with a specific Home Agent. This indication is considered only as a suggestion by the AAA server: it may happen, therefore, that the Home Agent allotted to the Mobile Node MN is not the one indicated in this TLV;
Home-Address-TLV: this is another optional TLV by means of which the Mobile Node MN may indicate a preferred Home Address; again, this is considered only as a suggestion by the AAA server and the Home Agent. This TLV is particularly useful when the Mobile Node has a pre-configured security relationship with a specific Home Agent or in the case of AAA server failover,
Interface-Identifier-TLV: this is still another optional TLV by means of which the Mobile Node MN may indicate an interface identifier to be used by the Home Agent for constructing the Home Address starting from the selected home prefix.

In the case the Mobile Node MN indicates by means of the Service-Selection-TLV that it does not wish to use the Mobile IP service, the AAA server terminates communication as better detailed in the following.

Conversely, when the Mobile Node MN wishes to negotiate the Mobile IP service, the AAA server determines a Home Agent HA adapted for that purpose by using a Home Agent selection algorithm. A detailed description of that algorithm is beyond the scope of this application. The variables to be taken into account for selecting an optimum Home Agent are: the position of the Mobile Node, the suggestions provided by the Mobile Node by means of the Home-Address-TLV and the Home-Agent-Address-TLV, the current number of users (load) served by each of available Home Agents, and so on.

As soon as a suitable HA has been identified, the AAA server interacts with it to dynamically configure all the state needed to enable subsequent Mobile IPv6 protocol operations. This kind of operation is highlighted in FIG. 8, where the block 600 designates the Home Agent selection and the steps 602 and 604 correspond to the following messages.

| | |
|---|---|
| 600 | Home Agent Selection |
| 602 | Home-Address-Request (User-Name-AVP, |
| | [HA-Features-AVP], [Home-Address-AVP], |
| | [Interface-Identifier-AVP]) |
| 604 | Home-Address-Answer (User-Name-AVP, |
| | Home-Address-AVP) |

For communication between the AAA server and the Home Agent HA, Diameter is preferably used by defining a new application. This means that the Home Agent must also support the Diameter protocol and, specifically, the Diameter Base Protocol (see rfc3588) and the application described herein.

Once the Home Agent has been selected, the AAA server sends a Diameter message called Home Address Request containing a User-Name AVP with the Network Access Identifier for the user (see the diagram of FIG. 8). In the case the Mobile Node MN has previously indicated a Home Address (or an interface identifier), the AAA server includes in this message also a Home-Address AVP (or an Interface-Identifier AVP) containing the hints provided by the Mobile Node. Additionally, the AAA server may insert a HA-Features AVP to request from the Home Agent HA the availability of possible additional functions requested by the Mobile Node (for instance, the possibility to register multiple Care-of Addresses).

The Home Agent chooses a Home Address for the Mobile Node by generating an interface identifier (for example based on rfc3041) or, possibly, by using the identifier indicated by the user in the Interface-Identifier-TLV. Then, the Duplicate Address Detection (DAD) procedure is performed for the selected Home Address as indicated in FIG. 8.

If the DAD procedure is completed successfully, the Home Agent HA starts defending the address by means of the Proxy Neighbour Discovery protocol in a manner identical as provided in the Mobile IP specification (see draft-ietf-mobileip-ipv6-24, pages 72-73) and sends a Home Address Answer message by indicating the NAI of the user (within a User-Name AVP) and the address selected (within a Home-Address AVP). In the case the DAD procedure is not successful, the Home Agent HA repeats the whole procedure starting from the Home Address generation step. If the procedure fails for a number of times (for instance three times) the Home Agent HA sends the Home Address Answer message to the AAA server with Result-Code=FAILURE. Error management may be made more comprehensive by defining different Result-Codes depending on the type of error.

In this latter case, for instance, one may use Result-Code-FAILURE_DAD.

Specific attention must be devoted to the procedure used by the HA to defend the Home Address, in that the following situation may occur. The Home Agent HA communicates to the AAA server a Home Address and starts defending that address. Based on the Mobile IPv6 standard, when the Home Agent is reached by a Binding

Update (BU) message that is not an updating of an entry already existing within the Binding Cache (that is, the first MIPv6 registration message sent by the Mobile Node), it must perform the DAD procedure for the Home Address contained in the BU. Since the same Home Agent HA is already defending that address, it may happen that it considers the address in question as already taken, and therefore, rejects the MIPv6 registration request. In order to solve that problem, when the Home Agent sends the Home Address Answer message containing a Home Address, a dummy entry is inserted in the Binding Cache including the Home Address and an Unspecified Address (such as ::) as the Care-Of Address. In that way, the BU message reaching the Home Agent does not correspond to the creation of a new entry but just to an updating of an already existing entry, whereby the Home Agent does not performs the DAD procedure.

The arrangement described herein also provides for the AAA server to perform the role of Key Distribution Centre for the Mobile Node MN and the Home Agent HA by sending the cryptographic information to both nodes in such a way to permit bootstrapping of the security relationship mandated by the MIPv6 standard. The procedure provides for the AAA server to perform an IKE Configuration Selection 700 and send to the Home Agent HA a Home Agent Configuration Request message 701 containing the following Attribute Value Pairs or AVPs (see FIG. 9):
User Name AVP with the user's NAI,
Authorization-Lifetime AVP in order to indicate to the Home Agent HA how long the Mobile Node MN is authorized to user the Mobile IP service,
IKE-Bootstrap-Information AVP (IKE being an acronym for Internet Key Exchange), where the AAA server indicates to the Home Agent HA the way of negotiating the IPsec security relationship with the Mobile Node MN: for that purpose, it is specified the type of authentication to be used in the first phase of IKE (only the case with the Pre-Shared Key is considered), the Pre-Shared Key to use and the corresponding lifetime (which may also be infinite). In that way, the Home Agent HA acquires all the information needed for negotiating with the Mobile Node MN the IPsec Security Association; and

in addition to that information, the AAA server may also send a Policy AVP indicating a set of policies (for example, filtering rules) to be enforced by the Home Agent on the Mobile Node traffic.

The need therefore arises for the Home Agent to store for each user a set of information items concerning the authorization to use the Mobile IP service and the cryptographic material required for activating the service itself.

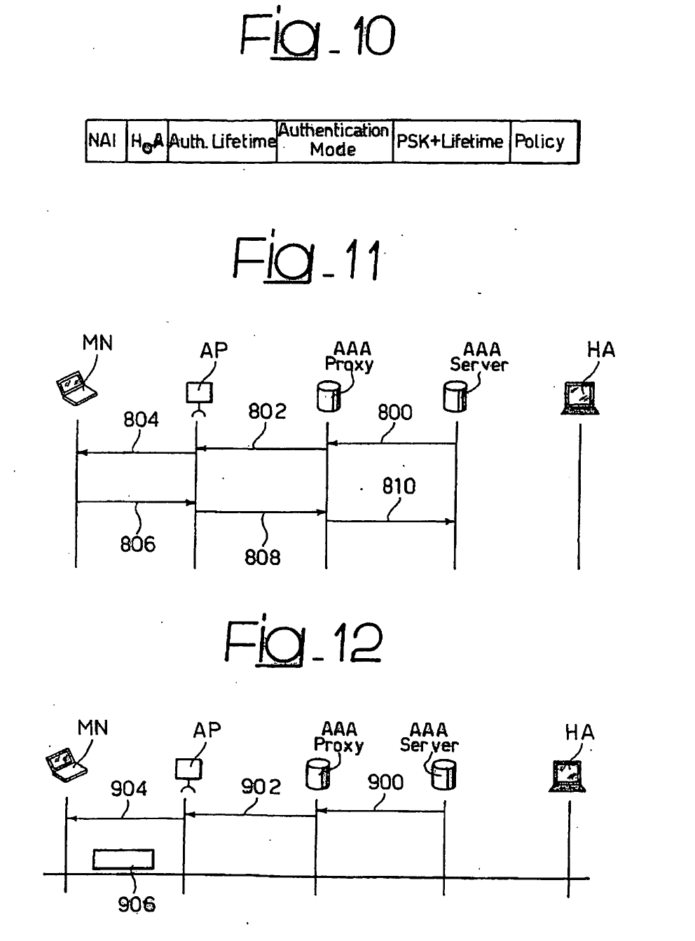

For that purpose, a data structure, called Service Authorization Cache, is used. As shown in FIG. 10, the structure includes the following fields:
NAI: contains the Network Access Identifier (that is, the identity) of the user; the Home Agent fills in that field with the contents of the User Name AVP sent by the AAA server,
HoA: it contains the Home Address that the Home Agent has selected, and is already defending, for that user; that field represents the meeting point of the instant data structure and the Binding Cache provided by the Mobile IPv6 standard to maintain a correspondence between the Home Address and the Care-of Address (see draft-ietf-mobileip-ipv6-24, page 18),
Authorization Lifetime: it contains the value included in the Authorization-Lifetime AVP sent by the AAA server. This value represents the time for which the Mobile Node is authorized to use the Mobile IP service. At the expiration of this lifetime, the Home Agent sends to the AAA server an Authorization Refresh Request to obtain an extension in time of the authorization or possibly discontinue the service,
Authentication Mode: indicates the method to use for peer authentication in first phase of IKE; for the sake of simplicity only the case of Pre-Shared Key is considered,
PSK: it contains the Pre-Shared Key to use for IKE bootstrapping; this field may possibly contain also the associated lifetime (for the sake of simplicity this lifetime may be considered to be infinite), and
Policy: this part of the cache contains the policies to be enforced by the Home Agent HA on the Mobile Node traffic (that is, the filtering rules communicated by the AAA server in the Policy-AVP).

Once these information items have been stored, the Home Agent HA sends to the AAA server (in a step 702) a Home Agent Configuration Answer message. This message is intended to confirm, by means of a Result-Code AVP, the success of registration.

After receiving the Home Agent Configuration Answer message, the AAA server re-starts EAP communication with the Mobile Node. Therefore, it sends an EAP message, where, within the MIPv6-Authorization-TLV, the information concerning the Mobile IPv6 configuration is inserted in corresponding TLVs: the Home Address, the Home Agent Address and the information needed for IKE bootstrap.

The diagram of FIG. 11 essentially portrays the process of sending the configuration information to the Mobile Node. Specifically, the messages designated by reference numbers 800 to 810 in FIG. 11 have the following meanings/contents.

| | |
|---|---|
| 800 | Diameter-EAP-Answer |
| | Result-Code = DIAMETER_MULTI_ROUND_AUTH |
| | EAP-Payload-AVP (EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Boostrap-Information))) |
| 802 | Diameter-EAP-Answer |
| | Result-Code = DIAMETER_MULTI_ROUND_AUTH |
| | EAP-Payload-AVP (EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Boostrap-Information))) |
| 804 | EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Boostrap-Information)) |
| 806 | EAP-Response/EAP-Type = EAP-TLV |
| | (Result-TLV, Crypto-Binding-TLV, |
| | MIPv6-Authorization-TLV (Result)) |
| 808 | Diameter-EAP-Request |
| | EAP-Payload-AVP (EAP-Response/EAP-Type = EAP-TLV |
| | (Result-TLV, Crypto-Binding-TLV, |
| | MIPv6-Authorization-TLV (Result)) |
| 810 | Diameter-EAP-Request |
| | EAP-Payload-AVP (EAP-Response/EAP-Type = EAP-TLV |
| | (Result-TLV, Crypto-Binding-TLV, |
| | MIPv6-Authorization-TLV (Result)) |

Once the configuration information is received, the Mobile Node MN responds by means of a MIPv6-Authorization-TLV including a Result-TLV to indicate that the activation of the service has been accepted (see step 806 in FIG. 11). In fact, no certainty exists that the preferences possibly indicated by the Mobile Node (for instance, Home Address, Home Agent Address) have been accepted by the AAA server. For that reason, the possibility exists for the Mobile Node to reject activation of the service by indicating a given value in the Result-TLV. In that case, the AAA server communicates again with the Home Agent so that the Home Agent may release the resources previously assigned to the Mobile Node that has rejected the service. This communication is based on Abort Session Request and Abort Session Answer messages (see FIG. 17).

Communication between the AAA server and the Mobile Node MN is completed as shown in FIG. 12. There, the messages indicated by the reference numerals 900 to 906 have the following meaning:

| | |
|---|---|
| 900 | Diameter-EAP-Answer |
| | Result-Code = DIAMETER_SUCCESS |
| | EAP-Payload-AVP (EAP-Success) |
| | EAP-Master-Session-Key-AVP |
| | Authorization-AVPs (e.g. filtering and QoS rules) |
| 902 | Diameter-EAP-Answer |
| | Result-Code = DIAMETER_SUCCESS |
| | EAP-Payload-AVP (EAP-Success) |
| | EAP-Master-Session-Key-AVP |
| | Authorization-AVPs (e.g. filtering and QoS rules) |
| 904 | EAP-Success |
| 906 | EAP termination |

The AAA server sends a message with Result-Code equal to DIAMETER_SUCCESS and possible Authorization AVP for configuring filter policies on the access apparatus (in the instant case represented by the Access Point AP).

For the purposes of EAP communication between the AAA server and the Mobile Node, this latter has now all the information required for performing a Mobile IPv6 registration with the Home Agent allotted. In fact, the Mobile Node MN has now available its own Home Address, the Home Agent address, the cryptographic material for establishing a security relationship with the Home Agent. Additionally, as result of the procedure, the Mobile Node MN has also gained access to the visited link, and, therefore has obtained a Care-of Address via IPv6 auto-configuration (for example, rfc2462).

At this stage the Mobile Node MN undertakes all the steps necessary to activate Mobile IPv6 protocol operation (that is, the negotiation of the Security Association with IKE and the MIPv6 registration).

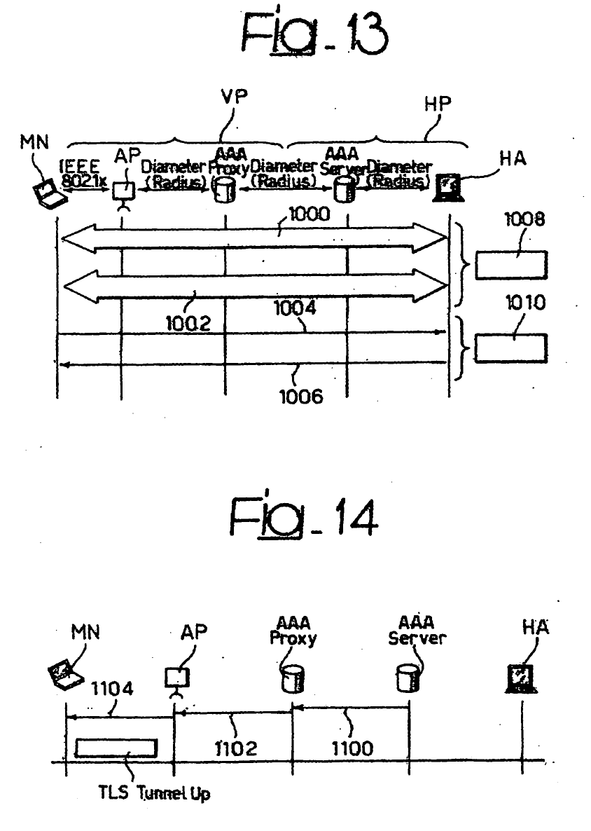

FIG. 13 shows an overview of the whole procedure. Again, a list is provided in the following of the meaning/contents of the steps designated by reference numbers 1000 to 1010 in FIG. 13.

| | |
|---|---|
| 1000 | IKE Phase 1 - Aggressive Mode (2 RTTs) |
| 1002 | IKE Phase 2 - Quick Mode (1 + ½ RTTs) |
| 1004 | MIPv6 Binding Update |
| 1006 | MIPv6 Binding Acknowledge |
| 1008 | IKE Negotiation |
| 1010 | MIPv6 Registration |

Setting up the Security Association between the Mobile Node MN and the Home Agent HA that protects (based on draft-ietf-mobileip-ipv6-24) the Mobile IPv6 signalling takes place as described in draft-ietf-mobileip-mipv6-ha-ipsec-04. Consequently, this part of the procedure is completely compliant with the standard.

In detail:
as shown in FIG. 13, the Aggressive Mode (occupying 2 RTT units) is used in the first IKE phase: as described in rfc2409, this way of operation exploits the authentication method based on the Pre-shared Key and the NAI as the identifier for the communicating peer. This is exactly the situation deriving from the procedure described previously: the Home Agent HA is not aware of the Care-of Address of the Mobile Node; however it is aware of its NAI and therefore may identify the corresponding Pre-shared Key via the NAI.
in the first IKE phase (indicated 1000 in FIG. 13) the source address of the Aggressive Mode messages is the Care-of Address and not the Home Address. The reasons for this are described in draft-ietf-mobileip-mipv6-ha-ipsec-04; therefore the Home Address is present only in the messages comprising the second IKE phase, indicated 1002 in FIG. 13,
the second IKE phase 1002 (which is Quick Mode, taking 1+½ RTT units) exploits the Home Address as the Mobile Node identifier: this (as described in draft-ietf-mobileip-mtv6-ha-ipsec-04) is in order to permit the Home Agent to correctly configure the entries of the Security Policy Database and the Security Association Database.

Once the Security Association has been negotiated, the Mobile Node MN sends to the Home Agent HA the Binding Update message 1004 to register its own Care-of Address, thereby activating the Mobile IPv6 service. At this point, after the Home Agent HA sends a corresponding acknowledgment message 1006, the bootstrap procedure is completed and the Mobile Node can start communicating.

It will be appreciated that the procedure shown in FIG. 13 is essentially comprised of two subsequent phases, namely the IKE negotiation phase 1008 and the MIPv6 registration phase 1010.

The bootstrap procedure between the Mobile Node MN and the AAA server described in the foregoing requires 13.5 RTT units to be completed (9 RTTs for the negotiation phase, 3.5 RTTs for IKE and 1 RTT for MIPv6 registration).

A number of optimisation steps can be introduced in order to make the whole procedure faster, by saving one or more RTTs. However, since the whole procedure may be performed only at the Mobile Node bootstrap, the time requirements are not critical. The converse is true in the case the procedure is intended to be performed during Mobile Node handover.

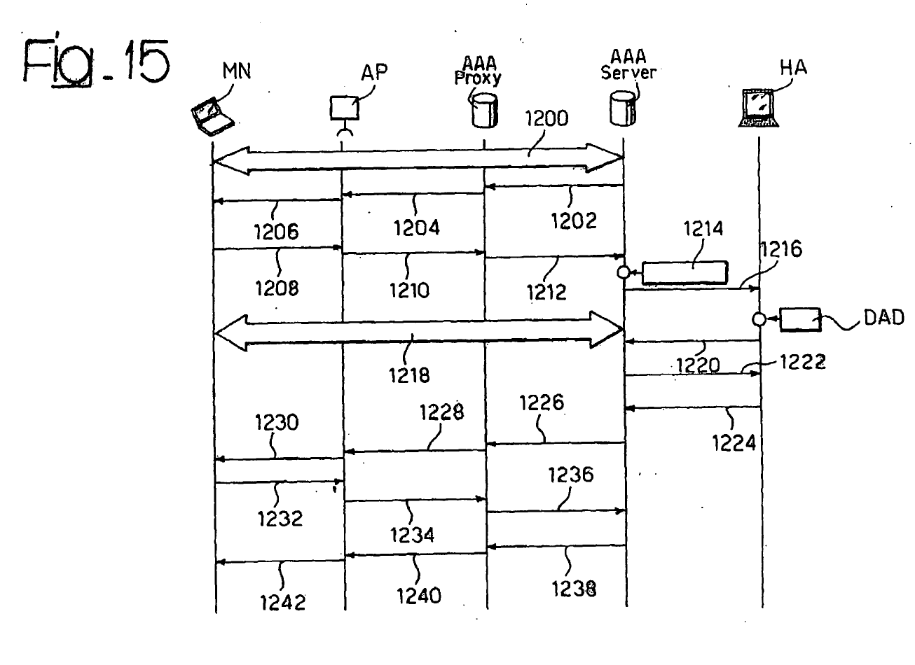

In the first place, the bootstrap procedure can be improved by using the optimisation introduced in draft-josefsson-pppext-eap-tls-eap-07 as shown in FIG. 14. There, the messages indicated by the reference numerals 1100, 1102 and 1104 have the following meanings:

| | |
|---|---|
| 1100 | Diameter-EAP_Answer |
| | Result-Code = DIAMETER_MULTI_ROUND_AUTH |
| | EAP-Payload-AVP (EAP-Request/EAP-Type = PEAP, V = 2 |
| | (TLS change_cipher_spec, TLS finished, |
| | EAP-Payload-TLV (EAP-Request/Identity))) |
| 1102 | Diameter-EAP_Answer |
| | Result-Code = DIAMETER_MULTI_ROUND_AUTH |
| | EAP-Payload-AVP (EAP-Request/EAP-Type = PEAP, V = 2 |
| | (TLS change_cipher_spec, TLS finished, |
| | EAP-Payload-TLV (EAP-Request/Identity))) |
| 1104 | EAP-Request/Identity |

In brief, the AAA server may insert the first message (400 in FIG. 6) of the second phase of PEAP (EAP Request Identity) within the message (336 in FIG. 5) completing the setting-up of the TLS tunnel. The resulting procedure is depicted in FIG. 14, where the AAA server sends a single message 1100 to perform both completion of TLS tunnel set-up and delivery of EAP Request Identity. In that way, one RTT is saved without engendering any changes in the procedure concerning negotiation of the Mobile IP service.

Additionally, the PEAPv2 protocol provides for the messages in the EAP communication being contained in TLVs called EAP-Payload-TLVs. In that way, several procedures can be performed simultaneously by using different TLVs for separating the different procedures.

Specifically, the negotiation procedure for the MIPv6 service can be performed in partial or complete superposition with the authentication procedure.

FIG. 15 shows the situation where the two procedures are completely superposed. Specifically, the messages indicated by the reference numerals 1200 to 1242 have the following meanings:

| | |
|---|---|
| 1200 | Identity exchange (1 RTT) |
| 1202 | Diameter-EAP-Answer |
| | Result-Code = DIAMETER_MULTI_ROUND_AUTH |
| | EAP_Payload-AVP (EAP-Request/EAP-Type = EAP-TLV |
| | (EAP-Payload-TLV (EAP_Request/EAP-Type = X), |
| | MIPv6-Authorization-TLV |
| | (Service-Status, [Service-Options]))) |
| 1204 | Diameter-EAP-Answer |
| | Result-Code = DIAMETER_MULTI_ROUND_AUTH |
| | EAP_Payload-AVP (EAP-Request/EAP-Type = EAP-TLV |
| | (EAP-Payload-TLV (EAP_Request/EAP-Type = X), |
| | MIPv6-Authorization-TLV |
| | (Service-Status, [Service-Options]))) |
| 1206 | EAP-Request/EAP-Type = EAP-TLV |
| | (EAP-Payload-TLV (EAP_Request/EAP-Type = X), |
| | MIPv6-Authorization-TLV |
| | (Service-Status, [Service-Options])) |
| 1208 | EAP-Response/EAP-Type = EAP-TLV |
| | EAP-TLV (EAP-Payload-TLV (EAP-Response/EAP-Type = X), |
| | MIPv6-Authorization-TLV |
| | (Service-Selection, [Service-Options], |
| | [Home-Agent-Address], [Home-Address])) |
| 1210 | Diameter-EAP-Request |
| | EAP-Payload-AVP (EAP-Response/EAP-Type = EAP-TLV |
| | (EAP-Payload-TLV (EAP-Response/EAP-Type = X), |
| | MIPv6-Authorization-TLV (Service-Selection, |
| | [Service-Options], [Home-Agent-Address], |
| | [Home-Address]))) |
| 1212 | Diameter-EAP-Request |
| | EAP-Payload-AVP (EAP-Response/EAP-Type = EAP-TLV |
| | (EAP-Payload-TLV (EAP-Response/EAP-Type = X), |
| | MIPv6-Authorization-TLV (Service-Selection, |
| | [Service-Options], [Home-Agent-Address], |
| | [Home-Address]))) |
| 1214 | Home Agent Selection |
| 1216 | Home-Address-Request (User-Name-AVP, |
| | [HA-Features-AVP], [Home-Address-AVP], |
| | [Interface-Identifier-AVP]) |
| 1218 | Execution of the authentication method (N RTTs) |
| 1220 | Home-Address-Answer (User-Name-AVP, |
| | Home-Address-AVP) |
| 1222 | Home-Agent-Configuration-Request |
| | (User-Name-AVP, Authentication-Lifetime-AVP, |
| | IKE-Bootstrap-Information-AVP, [Policy-AVP]) |
| 1224 | Home-Agent-Configuration-Answer (User-Name-AVP, |
| | Result-Code-AVP) |
| 1226 | Diameter-EAP-Answer |
| | Result-Code = DIAMETER_MULTI_ROUND_AUTH |
| | EAP-Payload-AVP (EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Bootstrap-Information))) |
| 1228 | Diameter-EAP-Answer |
| | Result-Code = DIAMETER_MULTI_ROUND_AUTH |
| | EAP-Payload-AVP (EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Bootstrap-Information))) |
| 1230 | EAP-Request/EAP-Type = EAP-TLV |
| | (Result-TLV, Crypto-Binding-TLV, |
| | MIPv6-Authorization-TLV (Home-Address, |
| | Home-Agent-Address, IKE-Bootstrap-Information)) |
| 1232 | EAP-Response/EAP-Type = EAP-TLV |
| | (Result-TLV, Crypto-Binding-TLV, |
| | MIPv6-Authorization-TLV (Result)) |
| 1234 | Diameter-EAP-Request |
| | EAP-Payload-AVP (EAP-Response/EAP-Type = EAP-TLV |
| | (Result-TLV, Crypto-Binding-TLV, |
| | MIPv6-Authorization-TLV (Result))) |
| 1236 | Diameter-EAP-Request |
| | EAP-Payload-AVP (EAP-Response/EAP-Type = EAP-TLV |
| | (Result-TLV, Crypto-Binding-TLV, |
| | MIPv6-Authorization-TLV (Result))) |
| 1238 | Diameter-EAP-Answer |
| | Result-Code = DIAMETER_SUCCESS |
| | EAP-Payload-AVP (EAP-Success) |
| | EAP-Master-Session-Key-AVP |
| | Authorization-AVPs (e.g. filtering and Qos |
| | rules) |
| 1240 | Diameter-EAP-Answer |
| | Result-Code = DIAMETER_SUCCESS |
| | EAP-Payload-AVP (EAP-Success) |
| | EAP-Master-Session-Key-AVP |
| | Authorization-AVPs (e.g. filtering and Qos |
| | rules) |
| 1242 | EAP-Success |

In detail, in the arrangement shown in FIG. 15:
the AAA server sends the MIPv6-Authorisation-TLV containing the Service-Status-TLV in the same EAP message starting the authentication procedure (1202);
once the indication is received from the Mobile Node MN to activate the Mobile IP service, the AAA server selects a suitable HA (1214) and starts the communication with it by sending the Diameter Home Address Request message 1216. In the meantime, the authentication procedure with the Mobile Node is continued,
the Home Agent HA performs the procedure described in the foregoing for a non-optimised bootstrap procedure: it determines Home Address for the Mobile Node, performs the DAD procedure and subsequently sends the Home Address Answer message 1220;
the AAA server continues the authentication procedure for the user (that is the Mobile Node MN); before completing that procedure by sending the RAP message containing the Result-TLV it completes the configuration for the Home Agent (by sending the Home Agent Configuration Request message 1222). Once the confirmation is received from the Home Agent (message 1224), the AAA server communicates to the Mobile Node MN the successful conclusion of the procedure, by also adding the MIPv6-Authorisation-TLV in order to communicate to the Mobile Node MN the Mobile IPv6 configuration parameters (messages 1226, 1228, 1230).

This kind of optimisation leads to saving two RTTs in comparison with the previous case. Both exchanges for negotiating the Mobile IP service are in fact absorbed in the authentication procedure. Consequently, by using the two optimisation steps considered, the procedure time occupation is decreased from 9 to 6 RTTs. Additionally, the time for the Home Agent to complete the DAD procedure is partially or totally absorbed within the authentication procedure.

The authentication and authorization steps to gain access to the network are repeated by the Mobile Node MN at certain time-outs and in the case of displacement involving a change of point of attachment (e.g. Access Point) into the network. In that case re-authentication procedure is performed leading to the user identity to be checked again along with his or her right to continue exploitation of the network resources. To that purpose the server may repeat a full authentication or, alternatively, decide to use optimisations in order to make the procedure faster. Once this phase is completed the AAA server starts the re-negotiation phase of the Mobile IP service. This may occur in different ways depending on the service state for the user involved.

If the service is not currently active for the user, the server behaves exactly as in the bootstrap phase described in the foregoing proposing activation of the service itself by means of the MIPv6-Authorization-TLV. The Mobile Node responds as previously described.

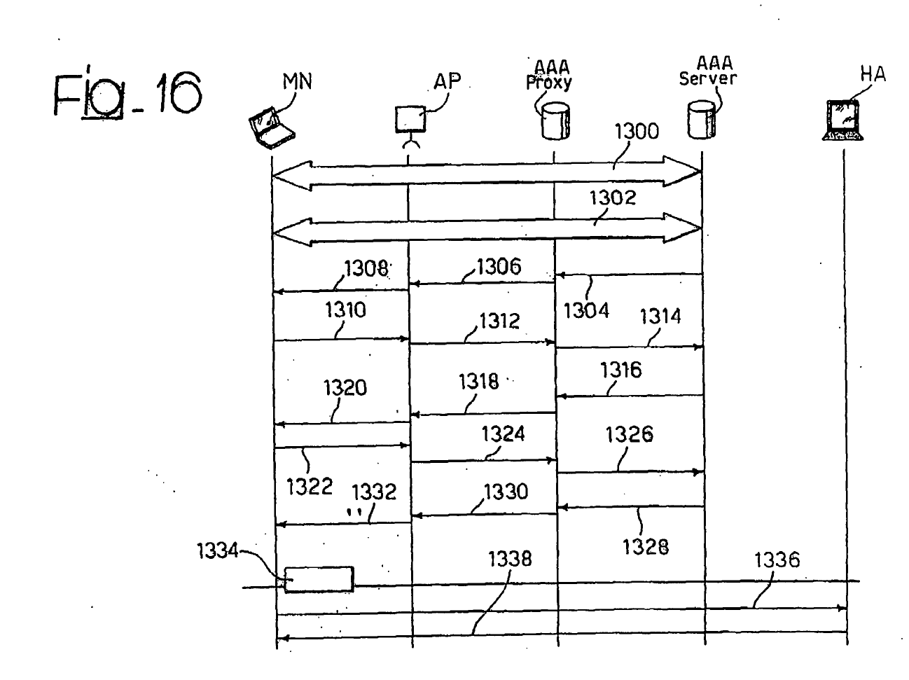

If the service is already active for the user, the server sends the MIPv6-Authorization-TLV with the Service-Status-TLV and Service-Options-TLV as shown in FIG. 16.

More specifically, the steps/messages indicated by the reference numerals 1300 to 1338 in FIG. 16 have the following meanings/contents.

| | |
|---|---|
| 1300 | TLS Tunnel Set-Up (3 RTTs) |
| 1302 | Authentication (N RTTs) |
| 1304 | Diameter-EAP-Answer |
| | Result-Code = DIAMETER_MULTI-ROUND_AUTH |
| | EAP-Payload-AVP (EAP-Request/EAP-Type = EAP-TLV |
| | (MIPv6-Authorization-TLV |
| | (Service-Status, [Service-Options])) |
| 1306 | Diameter-EAP-Answer |
| | Result-Code = DIAMETER_MULTI-ROUND_AUTH |
| | EAP-Payload-AVP (EAP-Request/EAP-Type = EAP-TLV |
| | (MIPv6-Authorization-TLV |
| | (Service-Status, [Service-Options])) |
| 1308 | EAP-Request/EAP-Type = EAP-TLV |
| | (MIPv6-Authorization-TLV ( |
| | Service-Status, [Service-Options])) |
| 1310 | EAP-Response/EAP˜Type = EAP-TLV |
| | (MIPv6-Authorization-TLV (Result)) |
| 1312 | Diameter-EAP-Request |
| | EAP-Payload-AVP (EAP-Response/EAP-Type = EAP-TLV |
| | (MIPv6-Authorization-TLV (Result))) |
| 1314 | Diameter-EAP-Request |
| | EAP-Payload-AVP (EAP-Response/EAP-Type = EAP-TLV |
| | (MIPv6-Authorization-TLV (Result))) |
| 1316 | Diameter-EAP-Answer |
| | Result-Code = DIAMETER_MULTI-ROUND_AUTH |
| | EAP-Payload-AVP (EAP-Request/EAP-Type = EAP-TLV |
| | (Result-TLV, Crypto-Binding-TLV)) |
| 1318 | Diameter-EAP-Answer |
| | Result-Code = DIAMETER_MULTI-ROUND_AUTH |
| | EAP-Payload-AVP (EAP-Request/EAP-Type = EAP-TLV |
| | (Result-TLV, Crypto-Binding-TLV)) |
| 1320 | EAP-Request/EAP-Type = EAP-TLV |
| | (Result-TLV, Crypto-Binding-TLV) |
| 1322 | EAP-Response/EAP-Type = EAP-TLV |
| | (Result-TLV, Crypto-Binding-TLV) |
| 1324 | Diameter-EAP-Request |
| | EAP-Payload-AVP (EAP-Response/EAP-Type = EAP-TLV |
| | (Result-TLV, Crypto-Binding-TLV)) |
| 1326 | Diameter-EAP-Request |
| | EAP-Payload-AVP (EAP-Response/EAP-Type = EAP-TLV |
| | (Result-TLV, Crypto-Binding-TLV)) |
| 1328 | Diameter-EAP-Answer |
| | Result-Code = DIAMETER_SUCCESS |
| | EAP-Payload-AVP (EAP-Success) |
| | EAP-Master-Session-Key-AVP |
| | Authorization-AVPs (e.g. filtering and Qos |
| | rules) |
| 1330 | Diameter-EAP-Answer |
| | Result-Code = DIAMETER_SUCCESS |
| | EAP-Payload-AVP (EAP-Success) |
| | EAP-Master-Session˜Key-AVP |
| | Authorization-AVPs (e.g. filtering and Qos |
| | rules) |
| 1332 | EAP-Success |
| 1334 | EAP termination |
| 1336 | MIPv6 Binding Update |
| 1338 | MIPv6 Binding Acknowledge |

In the re-authentication procedure shown in FIG. 16, the Mobile Node MN is informed of the Mobile IPv6 service status and the respective options and may thus respond in two different ways: by means of a SUCCESS type Result-TLV to indicate that the service configuration is wished to be maintained unchanged or by means of a MIPv6-Authorization-TLV containing those modifications that are sought in the service configuration (including the eventual indication to discontinue the service).

The example shown in FIG. 16 depicts the message exchange in the case the Mobile Node MN has decided—not to change—the current MIPv6 service configuration.

Conversely, if the Mobile Node MN has indicated the willingness to change the current Mobile IPv6 service configuration the AAA server responds by providing the parameters possibly necessary for re-configuring the service using the MIPv6-Authorization-TLV and the procedure goes on as in the bootstrap phase.

Upon completion of the re-authentication phase, including a possible re-negotiation of the service, the Mobile Node MN may proceed directly by sending the Binding Update message 1336 toward the Home Agent HA by using the IPsec Security Association negotiated during the bootstrap phase.

As a whole, the re-authentication procedure described takes 10 RTT units, when considering a method requiring two RTTs (for instance EAP-AKA) as the authentication method and assuming the Mobile Node thus not require any changes in the service configuration. Consequently, 3.5 RTT units are saved in comparison with the bootstrap phase in that the node already shares with the Home Agent HA the IPsec Security Association, whereby no need exists of repeating the IKE phase.

The delay involved in completing the re-authentication procedure may be reduced by resorting to the optimisation steps already described in the foregoing with reference to the bootstrap phase and, possibly by exploiting some additional optimisations included in the PEAPV2 protocol: for instance the fast resume of the TLS tunnel (see draft-josefsson-pppext-eap-tls-eap-07, pages 14-15) and the fast reconnect options described at pages 44-45 of the same reference document.

When utilization of the negotiated service is discontinued the session needs to be closed and the allocated resources (Home Agent, Home Address, and so on) released.

The session may be closed in two different ways depending whether such action is prompted by the AAA server or the Mobile Node MN.

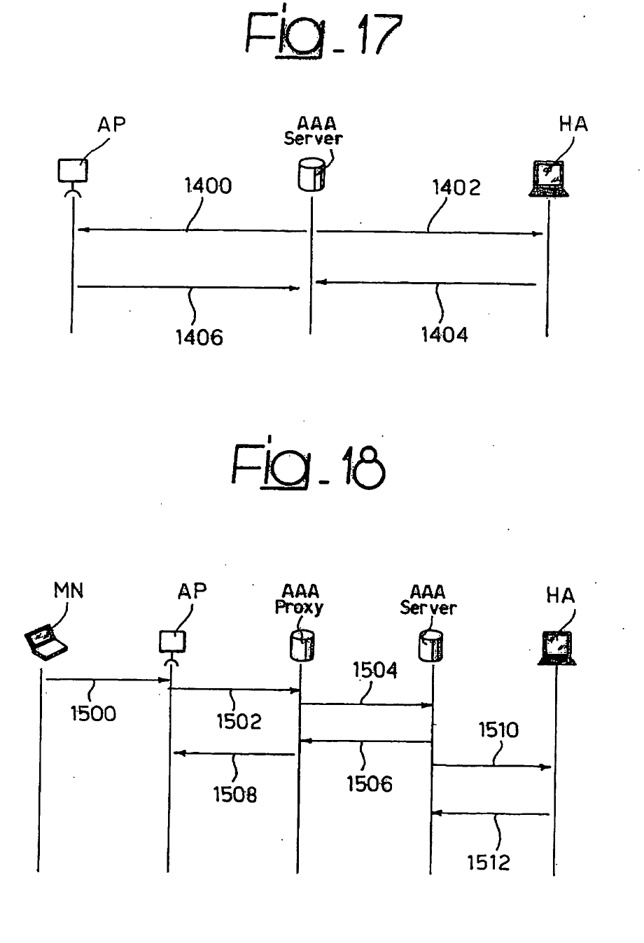

The diagrams of FIGS. 17 and 18 are representative of these two different options.

The AAA server may decide to close the session at any moment, for instance due to credit exhaustion or as result of a specific indication by the Mobile Node MN during the re-authentication phase. Generally speaking, in order to discontinue provision of the service, the server sends an Abort Session Request message to the Diameter client providing the service. The Diameter client forcibly disconnects the user, releases the resources possibly allocated and confirms the service having being discontinued by means of an Abort Session Answer message.

If a plurality of clients are involved in the service provision that is discontinued, the Abort Session message is sent to all the Diameter clients involved. In the specific case of the Mobile IP service, the two Diameter clients involved are the Home Agent and the point of attachment, that is the apparatus providing access to the network (for example the Access Point).

In the diagram of FIG. 17 the Abort Session Request messages sent toward those two Diameter clients are represented by 1400 and 1402, respectively. The corresponding answers are indicated by reference numerals 1404 and 1406.

| | |
|---|---|
| 1400 | Diameter-Abort-Session-Request (User-Name-AVP) |
| 1402 | Diameter-Abort-Session-Request (User-Name-AVP) |
| 1404 | Diameter-Abort-Session-Answer (Result-Code) |
| 1406 | Diameter-Abort-Session-Answer (Result-Code) |

In the case the Mobile Node MN wishes to disconnect from the network, the Mobile Node MN sends an EAPOL-Logoff message (1500 in FIG. 18) toward the Access Point AP which in turn communicates the end of the session to the AAA server via respective Diameter Session Termination Request messages 1502 and 1504 while simultaneously releasing the resources involved.

At the reception of the Session Termination Request message 1504, the AAA server releases the resources allocated on the HA exchanging Abort Session Request and Answer messages with it (represented by the messages 1510 and 1512 in FIG. 18) while sending a corresponding Diameter Session Termination Answer message (messages 1506 and 1508 in FIG. 18) toward the Access Point.

| | |
|---|---|
| 1500 | EAPOL-Logoff |
| 1502 | Diameter-Session-Termination-Request |
| 1504 | Diameter-Session-Termination-Request |
| 1506 | Diameter-Session-Termination-Answer |
| 1508 | Diameter-Session-Termination-Answer |
| 1510 | Diameter-Abort-Session-Request(User-Name-AVP) |
| 1512 | Diameter-Abort-Session-Answer(Result-Code) |

The AAA server may possibly decide to adopt different policies for releasing the resources depending on the service involved and/or the user profile.

For instance, for the Mobile IPv6 service, the AAA server may decide not to release the resources on the Home Agent HA in order to allow the user to exploit the service even when he or she moves to a network for which no roaming agreements exist (this be the case of a corporate network, or a network providing free and cost-free access). In that case, Security Association negotiated between the Mobile Node MN and the Home Agent is still valid and respective authorization is managed by means of the Authorization Lifetime. Once this lifetime expires (however, such lifetime may be of infinite duration, in which case the resources are not released until they are possibly re-negotiated as described in the foregoing) the Home Agent HA asks the AAA server to indicate if the provisioned service may be continued and decides whether the resources are to be released or not depending on the response received.

The arrangement described in the foregoing is applicable also when the user accesses a radio mobile network, such as a cellular telephone network (e.g. 2.5-3G), where EAP is not used for user authentication.

In 2.5-3G networks access control and IP address assignment are managed by means of protocols that are specific of cellular networks (for instance, SS7/MAP) and therefore do not support the use for EAP.

Based on the procedure used in radio mobile networks, at the end of registration operations, the user is allotted an IP address by activating a PDP Context. This corresponds to establishing a direct level-3 communication channel between the Mobile Node and the Gateway Serving/Support Node (GGSN).

Those of skill in the art will promptly appreciate that, even though derived from GPRS terminology, the designation GGSN is used herein to apply also to—any—node performing similar or equivalent functions in a network based on a standard different from GPRS.

In order to negotiate the Mobile IPv6 service on cellular networks using the same procedure defined in the foregoing for Wireless LANs, a level-3 transport for EAP is required. This may be offered by the PANA protocol (see draft-ietf-pana-pana-02). This protocol was originally created for access control, but may be used also for the sole purpose of negotiating and configuring additional services. Adaptation to mobile radio networks within the context of the present invention provides for a PANA session being set up between the Mobile Node MN and the GGSN node. During that session, the Mobile Node may communicate with the AAA server and negotiate (or re-negotiate) the Mobile IP service.

Once again, the meaning/contents of the various steps/messages indicated by the reference numerals 1600 to 1630 in FIG. 19 are reported herein below.

| | |
|---|---|
| 1600 | PDP Context Activation |
| 1602 | PANA-Start-Request |
| 1604 | PANA-Start-Answer |
| 1606 | Diameter EAP Request |
| | EAP-Payload-AVP(empty) |
| | User-Name-AVP(user@domain) |
| 1608 | Diameter EAP Answer |
| | Result-Code = DIAMETER_MULTI-ROUND_AUTH |
| | EAP-Payload-AVP(EAP-Request/EAP-Type = EAP-TLV |
| | (MIPv6-Authorization-TLV(Service-Status, |
| | Service-Options))) |
| 1610 | PANA-Auth-Request(EAP-Request/EAP-Type = EAP-TLV |
| | (MIPv6-Authorization-TLV(Service-Status, |
| | [Service-Options]))) |
| 1612 | PANA-Auth-Answer(EAP-Response/EAP-Type = EAP-TLV |
| | (MIPv6-Authorization-TLV(Service-Selection, |
| | [Service-Options]))) |
| 1614 | Diameter EAP Request |
| | EAP-Payload-AVP(EAP-Response/EAP-Type = EAP-TLV |
| | (MIPv6-Authorization-TLV(Service-Selection, |
| | [Service-Options]))) |
| 1616 | HA selection and communication with HA |
| 1618 | Diameter EAP Answer |
| | EAP-Payload-AVP(EAP-Request/EAP-Type = EAP-TLV |
| | (MIPv6-Authorization-TLV(Home-Address, |
| | Home-Agent-Address, IKE-Bootstrap-Information))) |
| 1620 | PANA-Auth-Request(EAP-Request/EAP-Type = EAP-TLV |
| | (MIPv6-Authorization-TLV(Home-Address, |
| | Home-Agent-Address, IKE-Bootstrap-Information))) |
| 1622 | PANA-Auth-Answer(EAP-Response/EAP-Type = EAP-TLV |
| | (MIPv6-Authorization-TLV(Result))) |
| 1624 | Diameter EAP Request |
| | EAP-Payload-AVP(EAP-Response/EAP-Type = EAP-TLV |
| | (MIPv6-Authorization-TLV(Result))) |
| 1626 | Diameter EAP Answer |
| | EAP-Payload-AVP(EAP-Success) |
| 1628 | PANA-Bind-Request(EAP-Success) |
| 1630 | PANA-Bind-Answer( ) |

The procedure shown in FIG. 19 includes the following phases.

Firstly, the GGSN node and the Mobile Node MN exchange two messages (1602 and 1604) to activate a PANA session within the PDP Context previously activated in a step 1600.

Subsequently, the GGSN node sends to the AAA server a Diameter EAP Request message 1606 containing the user identifier (NAI) and an empty EAP packet indicating to the server the need of starting an EAP exchange. The user identifier can be created starting from the data contained in the SIM/USIM of the user itself and does not require by way of necessity a domain insertion. In fact, the Mobile Node MN always activates a PDP context with a GGSN node managed by its Home Provider.

The NAI is constructed and inserted directly by the GGSN node and not by the Mobile Node MN. In this way the AAA server does not need to undertake a new authentication phase to verify the identity of the Mobile Node MN. This is because, the GGSN, which is a trusted node, communicates directly to the AAA server the identity with whom the user has activated the PDP Context and which was previously verified using protocols, other than EAP, specific of cellular networks (for instance, SS7/MAP).

At the reception of the Diameter FAP Request message 1606 from the GGSN, the AAA server understands that the user was already authenticated through SS7/MAP and starts directly the negotiation phase for the MIPv6 service, as defined in the foregoing, by means of an EAP-TLV message with the MIPv6-Authorization-TLV. This phase also includes a communication between the AAA server and the Home Agent HA which is repeated as described in the foregoing in the case of accessing WLAN.

Finally, an EAP Success message 1626 is sent by the AAA server to GGSN node, which forwards it to the Mobile Node (as a message 1628) via the PANA-Bind-Request. The Mobile Node MN confirms reception via the PANA-Bind-Answer message 1630.

The Mobile Node MN may request the termination of the PANA session, and consequently the release of the MIPv6 service, by means of a PANA-Termination-Request message sent to the GGSN node. Conversely, if delivery of the MIPv6 service is discontinued by the AAA server, the server sends a Diameter Abort Session Request message to the Home Agent HA.

Therefore, in comparison with the exemplary case considered in the foregoing (Wireless LAN), the user can just discontinue delivery of the Mobile IPv6 service while maintaining connection to the network. Instead, in the exemplary case considered in the foregoing, the user can discontinue the service only by re-negotiating it during re-authentication phase or by disconnecting from the network.

The main advantage of this procedure lies in the possibility of using again those messages and TLVs previously defined even when the user accesses a Radio Mobile Network. In that case, however, it is not generally possible to negotiate the Mobile IPv6 service while accessing the network as is the case when a WLAN network is accessed.

The final part of this description details the format of TLVs (Type Length Value) and AVPs (Attribute Value Pair) as defined previously.

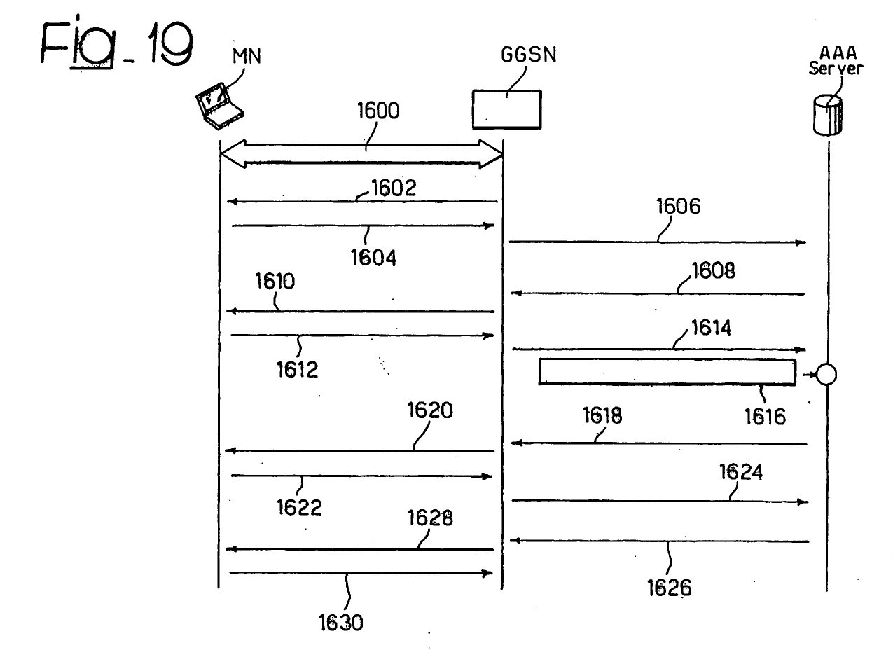

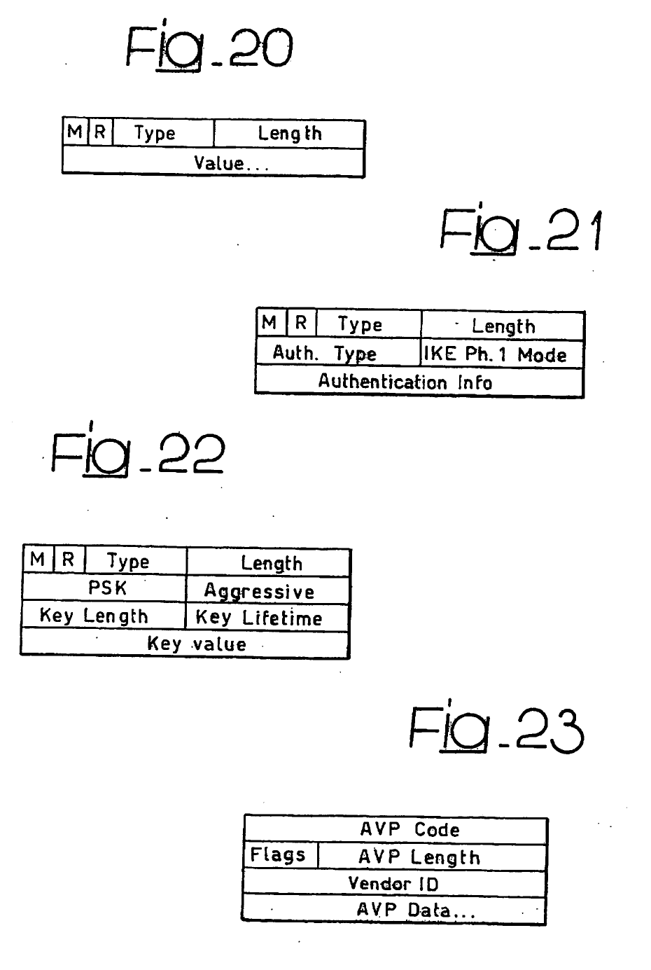

The general format of an EAP TLV is shown in FIG. 20. The bit M indicates if the TLV is a mandatory one. The bit R is reserved and set to 0. For all the TLVs defined herein the bit M is set to 0 (namely their use is not mandatory).

For a communication between the Mobile Node MN and the AAA server the following TLVs are defined:
MIPv6-Authorization-TLV: this is a generic TLV containing all the TLVs defined in the following and indicating the presence of information related to authorization, negotiation and configuration of the MIPv6 service. The field Value is not defined since this kind of TLV is used only to encapsulate the following,
Service-Status-TLV: in the value field only two bits are defined. The other bits are reserved. The meaning of the two bits is as follows:
11=Service active and available
10=Service active and no more available
01=Service not active and available
00=Service not available
Service-Selection-TLV: in the value field only two bits are defined. The other bits are reserved. The meaning of the two bits is as follows:
11=Deactivate service
10=Re-negotiate service
01=Activate service
00=The Mobile Node accepts what is being proposed by the server;
Service-Options-TLV: the format of this TLV is open and depending on the service options to be negotiated; the format is generally similar to the format of the previous TLV, possibly with variable sizes depending on the type of service to be negotiated.
Home-Agent-Address-TLV: it contains in Value field the address of the Home Agent HA;
Home-Address-TLV: it contains in Value field an IPvG address representing the home address allocated to the Mobile Node MN;
IKE-Bootstrap-Information-TLV: it contains the information needed to bootstrap the IKE procedure used for negotiating the Security Association between Mobile Node MN and Home Agent HA. The general format of this TLV is shown in FIG. 21. The Authentication Type field determines the type of authentication to be used for IKE phase 1 (for instance Pre-Shared Key, digital certificates).

The field designated IKE phase 1 Mode identifies the mode to be used in IKE phase 1 (that is Main Mode or Aggressive Mode).

The field designated Authentication Information contains the cryptographic material for negotiating the Security Association. The content of this field depends of the value of the field designated Authentication Type.

In the arrangement described herein only the use of a Pre-Shared Key has been defined. FIG. 22 shows the format of the IKE-Bootstrap-Information-TLV in this case. The Authentication Information field is subdivided in three fields: these are designated the

Key Length (and defines the length of the Pre-Shared Key),

Key Lifetime (indicating the lifetime of the Pre-Shared Key used; this can be set to an infinite value), and

Key Value (indicates the value of the key).
Result-TLV: it is used by the Mobile Node MN for indicating the success or failure of the MIPv6 negotiation procedure. Two possible values are considered for this TLV namely
01=Success
10=Failure

FIG. 23 shows the format of a generic AVP (as defined in rfc3588). Within the field designated Flags three bits have been defined for the time being indicating whether the AVP is a mandatory one, if it is vendor specific and if end-to-end security mechanisms have to be used.

The AVPs defined herein and used in communication between the AAA client and the AAA server and between the Home Agent HA and AAA server are as follows (the description is based on the conventions and type definitions specified in rfc3588):
Home-Address AVP: the field AVP Data of this AVP is of the IPAddress type and include the Home Address of the user.
Home-Agent-Address AVP: the AVP Data field of this AVP is of the IPAddress type and contains the address of the Home Agent.
IKE-Bootstrap-Information AVP: the AVP Data field of this AVP is of the OctetString type and contains information concerning the IKE bootstrap. The format of the AVP Data field is analogous to the format of the Value field concerning the IKE-Bootstrap-Information-TLV shown in FIGS. 21 and 22.
HA-Features AVP: it contains information about the features requested on the Home Agent (for instance, support for multiple registration).
Policy AVP: it carries the definition of the eventual filtering rules to be enforced on the HA for the traffic generated by the Mobile Node MN.

Furthermore other types of AVPs already defined in other documents where used namely:
User-Name AVP (AVP Code 1): it contains the user-name of the user in the form of a NAI: the AVP is of the UTF8String type;
Authorization-Lifetime AVP (AVP Code 291): this is an AVP of Unsigned32 type; the value contained in the AVP Data field represents the lifetime expressed in seconds of the authorization to use the service for a given user.

It will be appreciated that the exemplary embodiments of the invention considered in the foregoing refer to a situation where:
the access protocol is IEEE 802.1x,
the EAP protocol is used for transporting the authentication and authorization data,
the authentication method is based on PEAPv2,
the AAA backbone protocol is Diameter, and
the mobility management protocol is Mobile IPv6.

Those of skill in the art will promptly appreciate that the choices indicated in the foregoing are of purely exemplary nature and are in no way mandatory, the same applying also to the general context considered in the foregoing. Specifically, it will be appreciated that the invention may be applied not only for negotiating a Mobile IPv6 service but also e.g. a Mobile IPv4 service.

Those of skill in the art will promptly appreciate that a cellular telephone network as referred to in the foregoing is just one, non limiting example of those networks wherein EAP can be applied in order to implement the arrangement described herein even if the network, per se, uses methods other than EAP for authentication purposes.

Additionally, the architecture disclosed can be easily extended to arrangements wherein:
the access protocol is any protocol permitting the transportation of EAP messages (for example PANA as an alternative to IEEE 802.1x);
the authentication method is any EAP method providing for the set up of a tunnel to protect the exchange of authorization and configuration information between the Mobile Node and the AAA server. For that purpose, it is enough for the transport mechanism of the authentication information to provide for the presence of optional and extendable fields; and
the backbone protocol used between the AAA client and the AAA server is any protocol supporting the transport of EAP messages (such as e.g. Radius).

The invention has been described by taking as reference the EAP protocol, but as will be apparent to those skilled in the art, such a protocol can be replaced by any authentication protocol permitting the use of a backend authentication server (for example an AAA server) able to implement some or all authentication methods, with the access equipment (for example the AAA client) acting as a pass-through for some or all authentication methods.

According to the present invention, the term authentication method refers in particular to the messages exchanged between the mobile node and the backend authentication server at least for authentication purposes.

It is thus evident that, without prejudice to the underlined principle of the invention, the details and the embodiments may vary, also significantly, with respect to what has been described by way of example only, without departing from the scope of the invention as defined by the claims that follow.

1-118. (canceled)

119. A method for negotiating the provision of a mobile IP service between a mobile node and a server in a network, comprising the steps of:
providing an authentication protocol establishing a pass-through transport between said mobile node and said server; and
negotiating the provision of said mobile IP service via said authentication protocol over said pass-through transport.

120. The method of claim 119, wherein said authentication protocol is extensible authentication protocol (EAP).

121. The method of claim 120, comprising the step of selecting said transport as either of a level-2 or level-3 EAP transport.

122. The method of claim 120, comprising the step of providing in said network a client node between said mobile node and said server, wherein said client node plays a pass-through role and is not involved in said negotiation.

123. The method of claim 122, comprising the step of providing between said client node and said server an EAP transport selected from diameter and radius.

124. The method of claim 122, comprising the step of configuring said client node as a point of attachment to said network working as an access point.

125. The method of claim 122, comprising the step of configuring said client node as a point of attachment to said network working as a router.

126. The method of claim 119, wherein said step of negotiating comprises at least one of:
authorizing said mobile node to use said mobile IP service;
communicating to said mobile node a set of options for use of said mobile IP service;
dynamically configuring a set of parameters required for using said mobile IP service; and
configuring further options related to said mobile IP service.

127. The method of claim 120, comprising the step of routing messages for activating said mobile IP service between said mobile node and said server via said extensible authentication protocol (EAP) over said EAP transport upon at least one of said mobile node power up or connection of said mobile node to said network.

128. The method of claim 119, comprising the steps of:
providing in said network a home agent for communicating with said server; and
maintaining within said home agent configuration information for providing said mobile IP service.

129. The method of claim 128, comprising the step of providing an AAA backbone protocol for transferring said configuration information between said home agent and said server.

130. The method of claim 119, comprising the step of performing, upon at least one of said mobile node power up or connection of said mobile node to said network, a bootstrap procedure including steps selected from:
authorizing said mobile node to use said mobile IP service,
communicating to said mobile node options for use within said mobile IP service,
configuring the parameters for use of said mobile IP service, and
configuring service options communicated to said mobile node.

131. The method of claim 130, wherein said parameters comprise at least one of: a home address for use by said mobile node, the address of an associated home agent allotted thereto, and cryptographic data for bootstrapping a security association with said home agent.

132. The method of claim 119, comprising the steps of:
performing said method while said mobile node is roaming within a network different from the network of its home provider; and
providing a proxy for communication between said mobile node and said server under said roaming conditions.

133. The method of claim 120, comprising at least one of:
said mobile node sending a respective identifier toward said server,
setting up a transport layer security tunnel between said mobile node and said server to protect authentication information,
authenticating said mobile node with said server,
closing said EAP communication after authenticating said mobile node and negotiating said mobile IP service therefor, and
negotiating a security association between said mobile node and a respective home agent.

134. The method of claim 133, comprising, in association with said authentication, the step of said mobile node and said server exchanging a set of attributes selected from attributes for authorising, negotiating and configuring said mobile IP network.

135. The method of claim 133, wherein said step of negotiating said security association involves an IKE negotiation.

136. The method of claim 133, wherein said authentication is based on a defined EAP method.

137. The method of claim 133, wherein said authentication is SIM-CARD based.

138. The method of claim 119, wherein said step of negotiating comprises the step of said mobile node sending toward said server a message comprising a set of information items selected from:
service selection information items indicating the mobile node choice to activate said mobile IP service,
service option information items, representative of the service options to be activated,
an indication of a mobile node's preferred home agent,
an indication of a mobile node's preferred home address, and
an interface identifier for use by a home agent for constructing the mobile node's home address.

139. The method of claim 119, wherein said step of negotiating comprises said server selectively identifying a home agent for providing said mobile IP service.

140. The method of claim 139, comprising the step of:
said server sending a home address request message to said home agent comprising an identifier for said mobile node, and
said home agent allotting a home address for said mobile node.

141. The method of claim 140, wherein said step of allotting said home address comprises either generating an interface identifier or utilizing a mobile node's indicated interface identifier.

142. The method of claim 140, comprising the step of said home agent performing a duplicate address detection for said home address.

143. The method of claim 142, comprising, upon successful completion of said duplicate address detection, the step of said home agent preventing said home address allotted from being allocated to another user.

144. The method of claim 143, comprising the steps of providing in said home agent a binding cache and registering in said binding cache a dummy entry comprising said home address and an unspecified address as a care-of address, whereby any binding update reaching said home agent does not lead to the creation of a new entry.

145. The method of claim 119, comprising the steps of:
including in said network a home agent for providing said mobile IP service;
configuring said server as a key distribution centre between said mobile node and said home agent; and
sending from said server to said mobile node and said home agent cryptographic information to permit bootstrapping a security association between said mobile node and said home agent.

146. The method of claim 119, comprising the steps of:
including in said network a home agent for providing said mobile IP service; and
said server sending to said home agent a home agent configuration request message comprising information items selected from:
an identifier for said mobile node,
an authorization lifetime indicating how long said mobile node is authorized to use said mobile IP service,
bootstrap information for a security association between said mobile node and said home agent, and
a set of policies for said home agent to manage said mobile node's traffic.

147. The method of claim 146, comprising the step of providing in said network a home agent for communicating with said server said set of policies comprising information items representative of filtering rules to be enforced by said home agent on the mobile node traffic.

148. The method of claim 120, comprising at least one of the steps of:
said server sending an authorisation message for said mobile IP service within an EAP message starting said authentication step;
upon receiving the indication from said mobile node to activate said mobile IP service, said server sending a home address request message toward a selected home agent while continuing said authentication of said mobile node; and
said server continuing said authentication procedure of said mobile node by completing configuration of a respective home agent for providing said mobile IP service before completing said authentication procedure.

149. The method of claim 120, comprising the steps of:
selecting said network as a network using a respective authentication method other than EAP; and
using said EAP transport for said step of negotiating, while providing authentication by said respective authentication method other than EAP.

150. The method of claim 149, comprising the steps of:
selecting said network as a cellular network including a GGSN node; and
allotting to said mobile node an IP address by activating a PDP context, whereby a direct communication channel is established between said mobile node and said GGSN node.

151. A system for negotiating the provision of a mobile IP service between a mobile node and a server in a network, comprising an authentication protocol for establishing a pass-through transport between said mobile node and said server and being configured for negotiating the provision of said mobile IP service via said authentication protocol over said pass-through transport.

152. The system of claim 151, wherein said authentication protocol is extensible authentication protocol (EAP).

153. The system of claim 152, wherein said transport is either of a level-2 or level-3 EAP transport.

154. The system of claim 152, comprising a client node between said mobile node and said server, wherein said client node plays a pass-through role and is not involved in said negotiation.

155. The system of claim 154, comprising between said client node and said server, an EAP transport selected from diameter and radius.

156. The system of claim 154, wherein said client node is a point of attachment to said network configured as an access point.

157. The system of claim 154, wherein said client node is a point of attachment to said network configured as a router.

158. The system of claim 151, wherein said system is configured for performing at least one of:
authorizing said mobile node to use said mobile IP service,
communicating to said mobile node a set of options for use of said mobile IP service,
dynamically configuring a set of parameters required for using said mobile IP service, and
configuring further options related to said mobile IP service.

159. The system of claim 152, wherein said system is configured for routing messages for activating said mobile IP service between said mobile node and said server via said extensible authentication protocol (EAP) over said EAP transport upon at least one of said mobile node power up or connection of said mobile node to said network.

160. The system of claim 151, comprising a home agent for communicating with said server and maintaining configuration information for providing said mobile IP service.

161. The system of claim 160, comprising an AAA backbone protocol for transferring said configuration information between said home agent and said server.

162. The system of claim 151, wherein said system is configured for performing, upon at least one of said mobile node power up or connection of said mobile node to said network, a bootstrap procedure comprising steps selected from:
authorizing said mobile node to use said mobile IP service,
communicating to said mobile node options for use within said mobile IP service,
configuring the parameters for use of said mobile IP service, and
configuring service options communicated to said mobile node.

163. The system of claim 162, wherein said parameters comprise at least one of: a home address for use by said mobile node, the address of an associated home agent allotted thereto, and cryptographic data for bootstrapping a security association with said home agent.

164. The system of claim 151, comprising a proxy for communication between said mobile node and said server while said mobile node is roaming with a network different from the network of its home provider.

165. The system of claim 152, comprising at least one of:
an EAP communication transport between said mobile node and said server, whereby said mobile node is able to send a respective identifier toward said server;
a transport layer security tunnel between said mobile node and said server to protect authentication information;
an authentication function for authenticating said mobile node with said server;
an EAP communication closing function for closing said EAP communication after authenticating said mobile node and negotiating said mobile IP service therefor; and
a security association between said mobile node and a respective home agent.

166. The system of claim 165, comprising, in association with said authentication, a set of attributes to be exchanged between said mobile node and said server, said set of attributes selected from attributes for authorising, negotiating and configuring said mobile IP network.

167. The system of claim 165, wherein said security association is based on an IKE negotiation.

168. The system of claim 165, wherein said authentication is based on a defined EAP system.

169. The system of claim 165, wherein said authentication is SIM-CARD based.

170. The system of claim 151, wherein said mobile node is configured for sending toward said server a message comprising a set of information items selected from:
service selection information items indicating the mobile node choice to activate said mobile IP service,
service option information items, representative of the service options to be activated,
an indication of a mobile node's preferred home agent,
an indication of a mobile node's preferred home address, and
an interface identifier for use by a home agent for constructing the mobile node's home address.

171. The system of claim 151, wherein said server is configured for selectively identifying a home agent for providing said mobile IP service.

172. The system of claim 171, wherein
said server is configured for sending a home address request message to said home agent comprising an identifier for said mobile node, and said home agent is configured for allotting a home address to said mobile node.

173. The system of claim 172, wherein said home agent is configured for allotting said home address either by generating an interface identifier or by utilizing a mobile node's indicated interface identifier.

174. The system of claim 172, wherein said home agent is configured for performing a duplicate address detection for said home address.

175. The system of claim 174, wherein said home agent is configured for preventing said home address allotted from being allocated to another user upon successful completion of said duplicate address detection.

176. The system of claim 175, wherein said home agent has a binding cache and is configured for registering in said binding cache a dummy entry comprising said home address and an unspecified address as a care-of address whereby any binding update reaching said home agent does not lead to the creation of a new entry.

177. The system of claim 151, comprising:
a home agent for providing said mobile IP service;
said server configured as a key distribution centre between said mobile node and said home agent, for sending to said mobile node and said home agent cryptographic information to permit bootstrapping a security association between said mobile node and said home agent.

178. The system of claim 151, comprising:
a home agent for providing said mobile IP service, said server being configured for sending to said home agent a home agent configuration request message comprising information items selected from:
an identifier for said mobile node,
an authorisation lifetime indicating how long said mobile node is authorized to use said mobile IP service,
bootstrap information for a security association between said mobile node and said home agent, and
a set of policies for said home agent to manage said mobile node's traffic.

179. The system of claim 178, wherein said network comprises a home agent for communicating with said server, said set of policies comprising information items representative of filtering rules to be enforced by said home agent on the mobile node traffic.

180. The system of claim 152, configured for performing at least one of the steps of:
said server sending an authorisation message for said mobile IP service within an EAP message starting said authentication step,
upon receiving the indication from said mobile node to activate said mobile IP service, said server sending a home address request message toward a selected home agent while continuing said authentication of said mobile node, and
said server continuing said authentication procedure of said mobile node by completing configuration of a respective home agent for providing said mobile IP service before completing said authentication procedure.

181. The system of claim 152, wherein said network is a network having a respective authentication function other than EAP and said system is configured for using said EAP transport for said step of negotiating, while providing authentication by said respective authentication function other than EAP.

182. The system of claim 181, wherein said network is a cellular network comprising a GGSN node, and the system is configured for allotting to said mobile node an IP address by activating a PDP context, whereby a direct communication channel is established between said mobile node and said GGSN node.
